(19) United States
(12) Patent Application Publication
(10) Pub. No.: US 2006/0031159 A1
(43) Pub. Date: Feb. 9, 2006

(54) Methods, apparatus and articles-of-manufacture for marketing mortgage and/or credit services over the web

(76) Inventors: Hal Minot, Jacksonville, FL (US); Chuck Anderson, Jacksonville, FL (US); Deborah Moore, Jacksonville, FL (US); Sonia Neat, Jacksonville, FL (US); Mike Young, Atlantic Beach, FL (US); Charmaine Brent, Neptune Beach, FL (US); Tracy Peacock, Jacksonville, FL (US); Ed Wagner, Dallas, TX (US); Brian Hargrove, Plano, TX (US); Jeff Lium, Plano, TX (US)

Correspondence Address: MORGAN LEWIS & BOCKIUS LLP, 1111 PENNSYLVANIA AVENUE NW, WASHINGTON, DC, 20004, US

(21) Appl. No.: 11/202,273

(22) Filed: Aug. 10, 2005

Related U.S. Application Data
(62) Division of application No. 09/717,700, filed on Nov. 20, 2000.
(60) Provisional application No. 60/166,431, filed on Nov. 19, 1999.

(51) Int. Cl. G06Q 40/00

(52) U.S. Cl. 705/38

(57) ABSTRACT

Preferred embodiments of the present invention comprise a system and method for providing mortgage and/or credit services over the Internet. In one embodiment, a preferred method comprises: (a) selectively providing information concerning a plurality of mortgage and/or credit programs to an Internet-connected user; (b) receiving an indication of whether the user wishes to explore home financing options or home equity loan options; (c) receiving an indication of whether the user maintains an asset and/or brokerage account with a sponsor of the mortgage and/or credit services; (d) receiving an indication of the user's residence; (e) receiving information concerning a property to be financed, (f) receiving information concerning the user's investments; (g) processing the received information to determine mortgage and/or credit options that correspond to the user's needs; and (h) presenting those mortgage and/or credit options to the user via the Internet.

### CROSS-REFERENCE TO RELATED APPLICATION

The present application derives from, and claims the benefit of, U.S. Provisional Patent Application Ser. No. 60/166,431, filed Nov. 1, 1999, which prior application is hereby incorporated by reference.

### FIELD OF THE INVENTION

The present invention relates generally to the field of computer-assisted business methods, and to systems and articles-of-manufacture for implementing such methods. More particularly, the invention relates to computer-based methods, apparatus and articles-of-manufacture for marketing mortgage and/or credit services over the web.

### BACKGROUND OF THE INVENTION

Various attempts have been made to market credit and/or mortgage services over the Internet. However, to date, prior-art approaches have proved less than ideal in meeting the real-world needs of financial professionals and their clients.

Currently, most prior-art approaches have either taken the form of mere “promotional sites,” with very limited on-line functionality, or employed a model whereby the mortgage applicant is expected to navigate and complete the entire product selection and mortgage application process on-line. In reality, however, mortgage product selection and application/approval is a complex process, and neither of these prior-art models works well in the real world.

One particularly innovative approach to on-line mortgage selection/application is disclosed in U.S. Pat. No. 5,765,144, owned by the assignee of this application, and incorporated herein by reference. The '144 system is unique in that it permits both applicants and financial professionals (referred to herein as financial consultants (“FCs”) or client associates (“CAs”)) to access a variety of useful on-line resources.

While the '144 patent represents a significant advance over other prior-art approaches, it still has certain drawbacks. It would highly desirable to provide a web-accessible system that included the innovative features of the '144 invention, but also included a more comprehensive set of resources that enabled improved collaboration between financial professionals and their clients. The present invention comprises such a system.

### OBJECTS AND DESCRIPTION OF THE INVENTION

In light of the above, one general object of the invention relates to a Web-based improvement of the invention disclosed in the '144 patent.

Another general object of the invention relates to methods, systems and articles-of-manufacture for permitting financial professionals and their clients to collaborate, over the internet, in the mortgage/credit product selection and application process.

Yet another general object of the invention relates to methods, systems and articles-of-manufacture that enable consumers and financial professionals to obtain detailed information concerning available mortgage/credit products over the web, and to intelligently evaluate the costs/benefits of utilizing such products.

Still another general object of the invention relates to methods, systems and articles-of-manufacture for marketing mortgage/credit services over the web through multiple, interrupted sessions.

A yet further general object of the invention relates to methods, apparatus and articles-of-manufacture for providing appropriate, state-specific disclosures in connection with the on-line marketing of mortgage and/or credit services, and for ensuring that such disclosures meet appropriate legal requirements, such as the requirements that: (i) the disclosure information must appear in writing; (ii) the client be able to download and print the information, as well as acknowledge that the site allows him/her to do so; and/or (iii) the disclosure information be archived so that on any given date, it can easily be determined which version of a disclosure was presented to the client at the time the application was downloaded.

Still further objects of the invention relate to systems, methods and articles-of-manufacture which implement, in whole or in part, the web-based functionality described herein and/or in the incorporated '431 application.

Accordingly, generally speaking, and without intending to be limiting, one aspect of the invention relates to a computer-based method for marketing mortgage and/or credit services over the Internet, comprising: selectively providing information concerning a plurality of mortgage and/or credit programs to an Internet-connected user; receiving, from the Internet-connected user, an indication of whether the user wishes to explore home purchase options or home equity loan options; receiving, from the Internet-connected user, an indication of whether or not the user maintains an asset and/or brokerage account with the sponsor of the mortgage and/or credit services; receiving, from the Internet-connected user, an indication of the user's residence; receiving, from the Internet-connected user, information concerning a property to be financed, the information including at least location, expected holding period, and use of the property; receiving, from the Internet-connected user, information concerning the user's investments; processing the received indications and information to determine mortgage and/or credit option(s) that best match the user's needs; and presenting the mortgage and/or credit option(s) to the user via the Internet. Selectively providing information concerning a plurality of mortgage and/or credit programs may involve selectively providing information concerning zero-down payment and conventional mortgage programs, selectively providing information concerning fixed-rate and adjustable-rate options, and/or selectively generating pdf-format print files concerning selected mortgage and/or credit programs. Receiving, from the Internet-connected user, information concerning a property to be financed may involve receiving an indication of whether the property is a single family home, condominium, multi-family residence, or commercial property. Receiving, from the Internet-connected user, information concerning the user's investments may involve receiving information concerning the aggressiveness of the investments, receiving information concerning the expected rate-of-return on the investments, receiving information concerning the value of non-retirement securities held by the user, and/or receiving information concerning the portion of the non-retirement securities already pledged as collateral by the user. Presenting the mortgage and/or credit option(s) to the user via the Internet may involve providing a tabular comparison of at least three different down payment options. Providing a tabular comparison of down payment options may involve providing information concerning the costs/benefits of investing potential down payment funds. Presenting the mortgage and/or credit option(s) to the user via the Internet may also involve providing at least three options, each scored according to how well it meets the user's needs, may further involve selectively providing explanatory information concerning why the first option is the best option for the user's needs, and may still further involve selectively providing a comparison of one or more system-recommended option(s) with one or more user-selected option(s).

Again, generally speaking, and without intending to be limiting, another aspect of the invention relates to a computer-implemented method for marketing mortgage and/or credit services, over the Internet, to both financial consultants and retail customers, the method comprising: authenticating financial consultant users, so as to permit access, over the Internet, to selected consultant-exclusive resources; selectively providing information concerning a plurality of mortgage and/or credit programs to any Internet-connected user who requests such information; selectively receiving, from any Internet-connected user, an indication of whether the user wishes to explore home purchase options or home equity loan options; selectively receiving, from any Internet-connected user, residence location information; selectively receiving, from any Internet-connected user, information concerning a property to be financed, the information including at least location, expected holding period, and use of the property; selectively receiving, from any Internet-connected user, information concerning investments; selectively presenting, to any Internet-connected user, a plurality of ranked mortgage and/or credit option(s); and selectively presenting, to an Internet-connected financial consultant user, information concerning the financial consultant's clients. Selectively presenting, to an Internet-connected financial consultant user, information concerning the financial consultant's clients may involve selectively providing information concerning in-process applications of the financial consultant's clients, selectively providing information concerning mortgage(s) and/or line(s)-of-credit of the financial consultant's clients, and/or selectively providing information concerning production credits of the financial consultant. The method may further involve allowing an Internet-connected retail customer to save information and/or indications provided by the customer, allowing the Internet-connected retail customer to retrieve his/her previously-saved information and/or indications, and/or allowing an Internet-connected financial consultant user to retrieve previously-saved information and/or indications of his/her clients.

Again, generally speaking, and without intending to be limiting, another aspect of the invention relates to a computer-based system for marketing mortgage and/or credit services over the Internet, comprising: http-responsive means (of any sort, such as one or more network-connected computer(s)) for selectively providing information concerning a plurality of mortgage and/or credit programs to an Internet-connected user; http-responsive means for receiving, from the Internet-connected user, an indication of whether the user wishes to explore home purchase options or home equity loan options; http-responsive means for receiving, from the Internet-connected user, an indication of whether or not the user is an employee of the sponsor of the mortgage and/or credit services; http-responsive means for receiving, from the Internet-connected user, an indication of the user's residence; http-responsive means for receiving, from the Internet-connected user, information concerning a property to be financed; http-responsive means for receiving, from the Internet-connected user, information concerning the user's investments; means for processing the received indications and information to determine at least three mortgage and/or credit options that best match the user's needs; and http-responsive means for presenting the mortgage and/or credit options to the user via the Internet. The means for selectively providing information concerning a plurality of mortgage and/or credit programs may further include means for selectively providing information concerning zero-down payment and conventional mortgage programs, means for selectively providing information concerning fixed-rate and adjustable-rate options, and/or means for selectively generating pdf-format print files concerning selected mortgage and/or credit programs. The means for receiving, from the Internet-connected user, information concerning a property to be financed may include means for receiving an indication of whether the property is a single family home, condominium, multi-family residence, or commercial property. The means for receiving, from the Internet-connected user, information concerning the user's investments may further include means for receiving information concerning the expected rate-of-return on the investments over the expected holding period, means for receiving information concerning the value of non-retirement securities held by the user, and/or means for receiving information indicative of the portion of the non-retirement securities already pledged as collateral by the user. The means for presenting the mortgage and/or credit options to the user via the Internet may include means for providing a tabular comparison of at least three different down payment options. The means for providing a tabular comparison of down payment options may also provide information concerning the costs/benefits of investing potential down payment funds. The means for presenting the mortgage and/or credit options to the user via the Internet may include means for presenting at least three options, each scored according to how well it meets the user's needs, means for selectively providing explanatory information concerning why the first option is the best option for the user's needs, and/or means for selectively providing a comparison of one or more system-recommended option(s) with one or more user-selected option(s).

Again, generally speaking, and without intending to be limiting, another aspect of the invention relates to a computer-based system for marketing mortgage and/or credit services, over the Internet, to both financial consultants and retail customers, the system comprising: means for identifying certain Internet-connected users as financial consultants, thus enabling the identified users to access, over the Internet, selected consultant-exclusive resources; means for selectively presenting information concerning a plurality of mortgage and/or credit programs to any Internet-connected user who requests such information; means for selectively receiving, from any Internet-connected user, an indication of whether the user wishes to explore home purchase options or home equity loan options; means for selectively receiving, from any Internet-connected user, information concerning a property to be financed, the information including at least location, expected holding period, and use of the property; means for selectively receiving, from any Internet-connected user, information concerning investments; means for selectively presenting, to any Internet-connected user, a plurality ranked mortgage and/or credit option(s); and means for selectively presenting, exclusively to Internet-connected financial consultant users, information concerning the financial consultant's clients. The means for selectively presenting, to Internet-connected financial consultant users, information concerning the financial consultant's clients may include means for selectively providing information concerning in-process applications of the financial consultant's clients, means for selectively providing information concerning mortgage(s) and/or line(s)-of-credit of the financial consultant's clients, and/or means for selectively providing information concerning production credits of the financial consultant. The system may further include session storage means for allowing an Internet-connected retail customer to save information and/or indications provided by the customer during a session with the system, session retrieval means for allowing an Internet-connected retail customer to retrieve his/her previously-saved information and/or indications, and/or client session retrieval means for allowing an Internet-connected financial consultant user to retrieve previously-saved information and/or indications of his/her clients.

Still further aspects of the invention relate to alternative combinations, sub-combinations or supplemental combinations of the illustrative methods, systems and articles-of-manufacture described herein (and/or the individual elements, aspects and/or features thereof), consistent with, or in furtherance of, the objects, advantages and spirit of the instant invention.

### DESCRIPTION OF THE DRAWINGS

Various aspects, features and advantages of the instant invention are depicted in the accompanying set of figures, which is intended to be illustrative, rather than limiting, and in which:

FIG. 1 is a high-level site map of the exemplary Mortgage & Credit Solutions (or “Credit Advisor”) web site;

FIG. 2 provides additional detail concerning the Products Landing Page area of the Credit Advisor web site;

FIG. 3 provides additional detail concerning the Process Landing Page area of the Credit Advisor web site;

FIG. 4 is a flow diagram for a Purchase Profiler portion of the Credit Advisor web site;

FIG. 5 is a flow diagram for a Down Payment Analysis portion of the Credit Advisor web site;

FIG. 6 is a continuation of FIG. 5;

FIG. 7 is a flow diagram for a Product Recommendation Analysis portion of the Credit Advisor web site;

FIG. 8 is a flow diagram for the Product Classification Process portion of the process depicted in FIG. 7;

FIG. 9 is a flow diagram for the Product Scoring Process portion of the process depicted in FIG. 7;

FIG. 10 is a flow diagram for the Client Goal Scoring Process portion of the process depicted in FIG. 7;

FIG. 11 is a flow diagram for the Strategy One—First Mortgage Rate & Term Refinance Availability process;

FIG. 12 is a flow diagram for the Strategy Two—First Mortgage Rate & Term Refinance Availability process;

FIG. 13 is a flow diagram for the Strategy Three—Flexible First Strategy Availability process;

FIG. 14 is a flow diagram for the Strategy Four—Home Equity Loan or Line-of-Credit Availability process; and,

FIGS. 15-17 are flow diagrams which collectively depict the on-line application process.

### DETAILED DESCRIPTION OF THE PREFERRED EMBODIMENT

Further aspects and advantages of the present invention are discussed with reference to its presently-preferred embodiment, the Merrill Lynch Credit Advisor system, operated in part by Merrill Lynch Credit Corporation (“MLCC”).

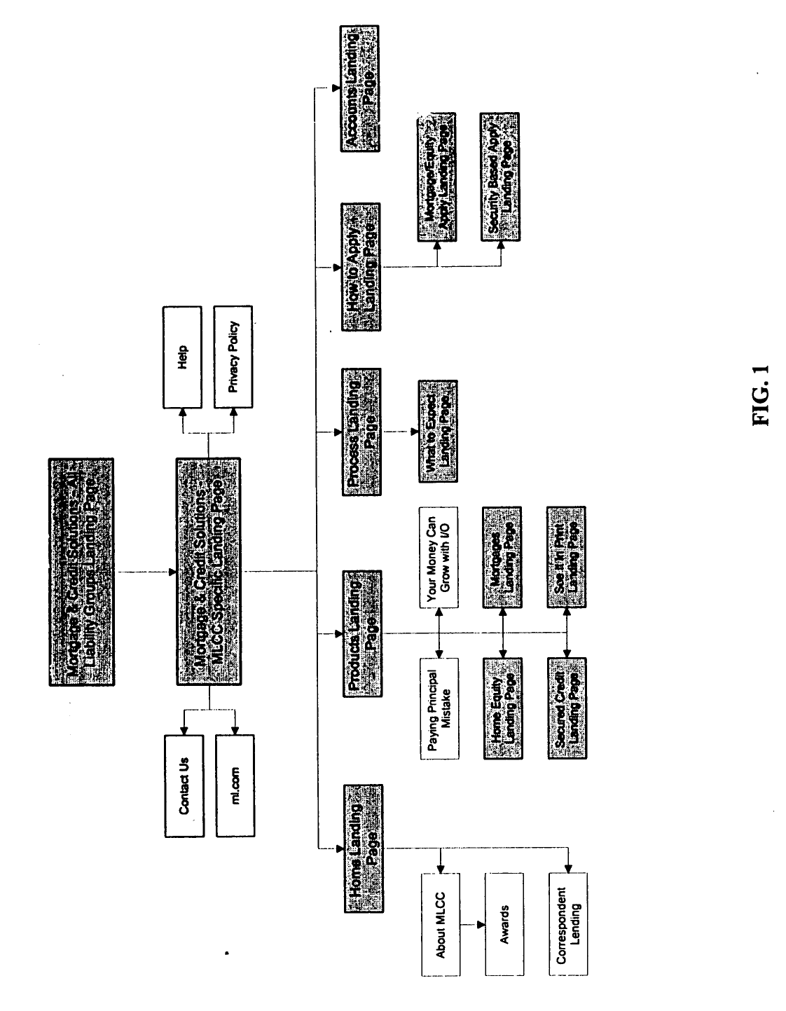

Reference is initially made to FIG. 1, which contains a high-level site map of the exemplary Credit Advisor system. The Products Offered section of the web site provides the user with information on the various products and programs offered by MLCC. The content within this section is arranged into the following categories of products and programs:

Mortgages

Home equity

Secured credit

Users are provided with a How to Apply link in each of the sections that will take them to the appropriate Apply Landing page for the product category they are interested in pursuing. In addition to the static content within this section, the user can also view and print PDFs of MLCC marketing materials, such as brochures and product fact sheets.

The Mortgages portion of the products section begins with the Home Financing Solutions Landing Page and is structured around the following pages:

1. Paying principal could be your costliest financial mistake page.

2. How your money could grow with interest-only payments page.

3. Fixed-rate mortgages page.

4. Fixed-to-adjustable rate mortgages page:
How to buy a larger home with a smaller mortgage payment;
customer profile page;

5. Adjustable rate mortgages page:
Adjustable rate mortgages, one or six month adjustment period page;

6. Will a down payment help or hurt you page:
Traditional down payment and mortgage insurance page;
Mortgage 100 program page;
Parent Power program page;
Eligible securities page;

7. Construction-to-permanent page:
Construction-to-permanent program helps homeowner avoid home financing headache;
customer profile page;

8. Mortgage/equity combo (Flexible First) page.

9. Qualified Buyer program.
Qualified Buyer program enrollment form (PDF);
Qualified Buyer certificate (PDF).

The Secured Credit portion of the products section begins with the Secured Credit Landing Page and is structured around the following pages:

1. Eligible securities page.

2. Omega account page.

3. Investor Credit Line Services page:
How to diversify your portfolio and prevent a tax hit with securities-based credit;
client profile page.

4. Flexible Credit account page.

If the user would like additional information on any of the products and/or programs offered by MLCC, he/she can use the See It In Print section of the site to access PDFs of MLCC marketing materials. In order to view these PDFs, the user must have Adobe Acrobat Reader loaded on his/her computer. If he/she does not, he/she is provided with a link from this page to the Adobe web site where the reader can be downloaded for free.

The following PDFs are preferably available in the See It In Print section, separated by category.

1. Liability Management Category:
Credit management solutions.

2. Home Financing Category:
How to turn your mortgage into an asset;
The Mortgage 100 program;
Construction-to-permanent program;
Prime First self-directed mortgage;
Fixed-to-adjustable rate mortgages;
Fixed-rate mortgages;
Mortgage 100 and Parent Power programs;
Flexible First program;
Do you want a larger house, but a smaller mortgage payment?
Merrill Lynch Qualified Buyer program;
Qualified Buyers enrollment form;
Builder/contractor data sheet.

3. Home Equity Lending Category:
Home equity credit solutions;
Equity Access Fixed.

4. Security-Based Lending Category:
Omega account;
Flexible Credit account.

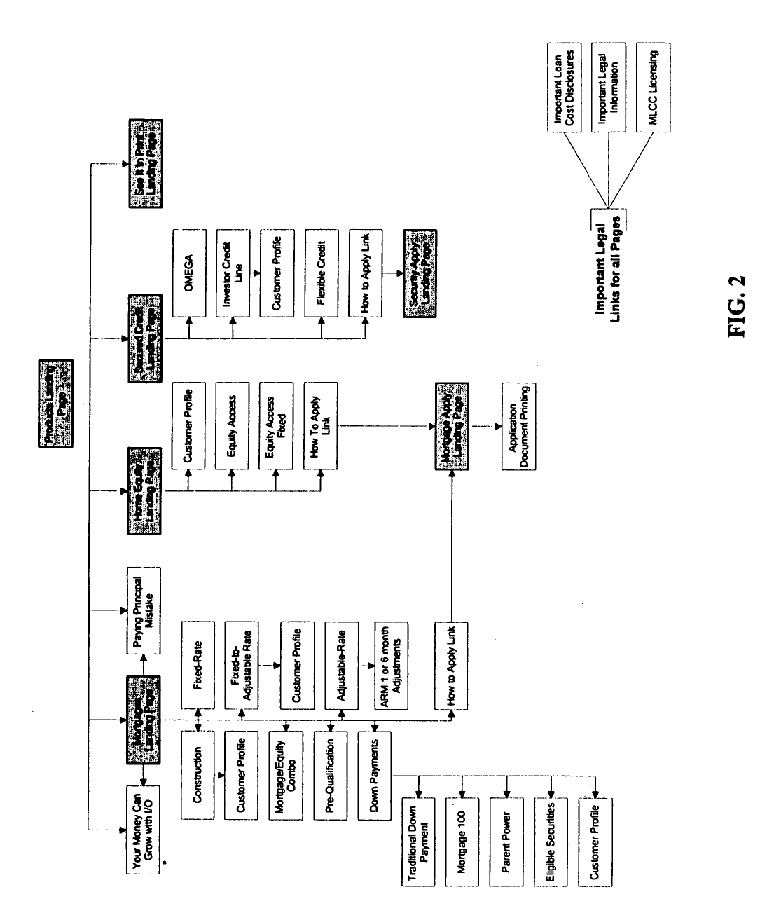

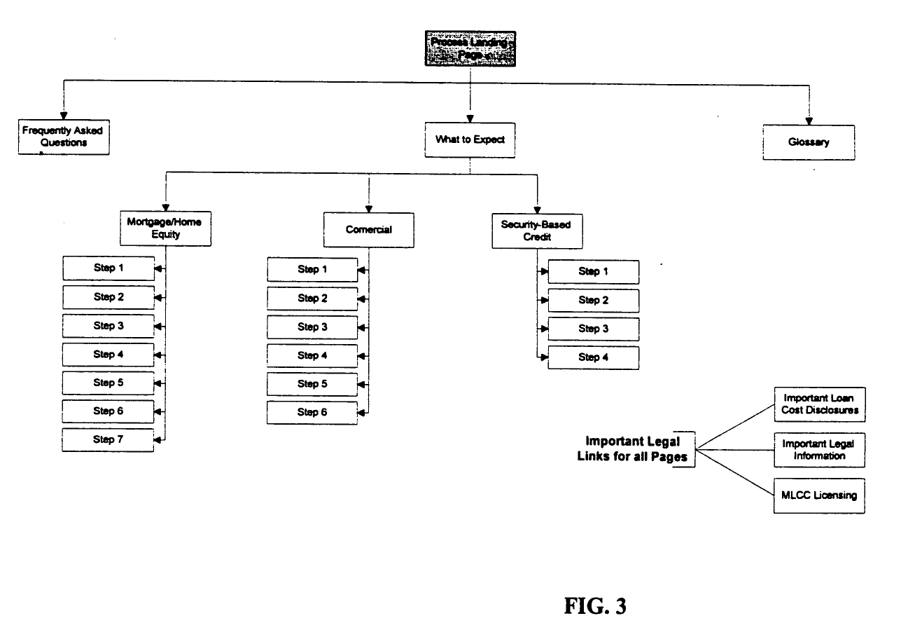

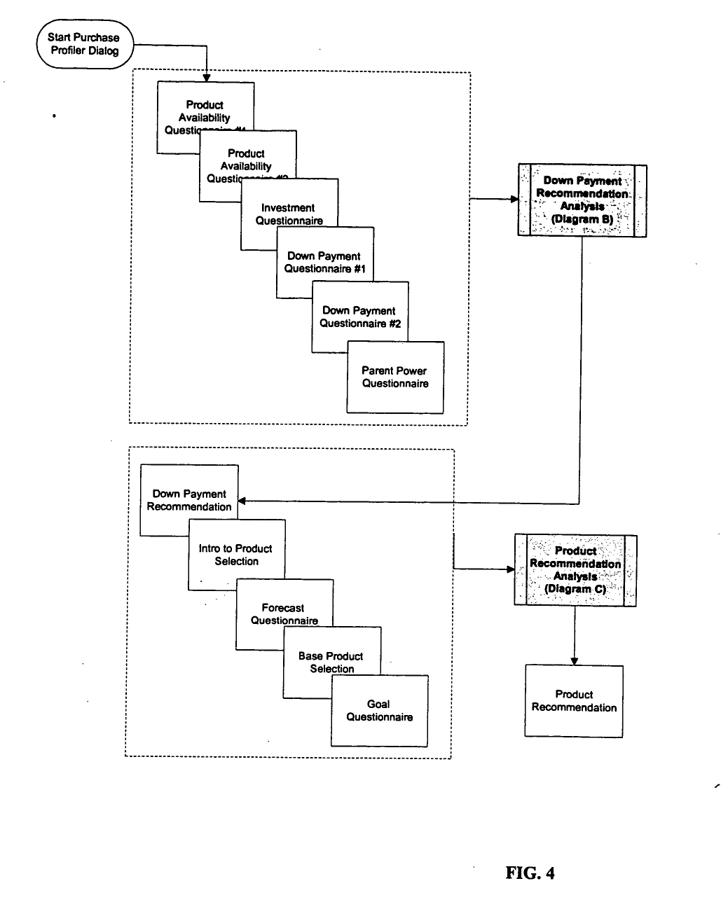

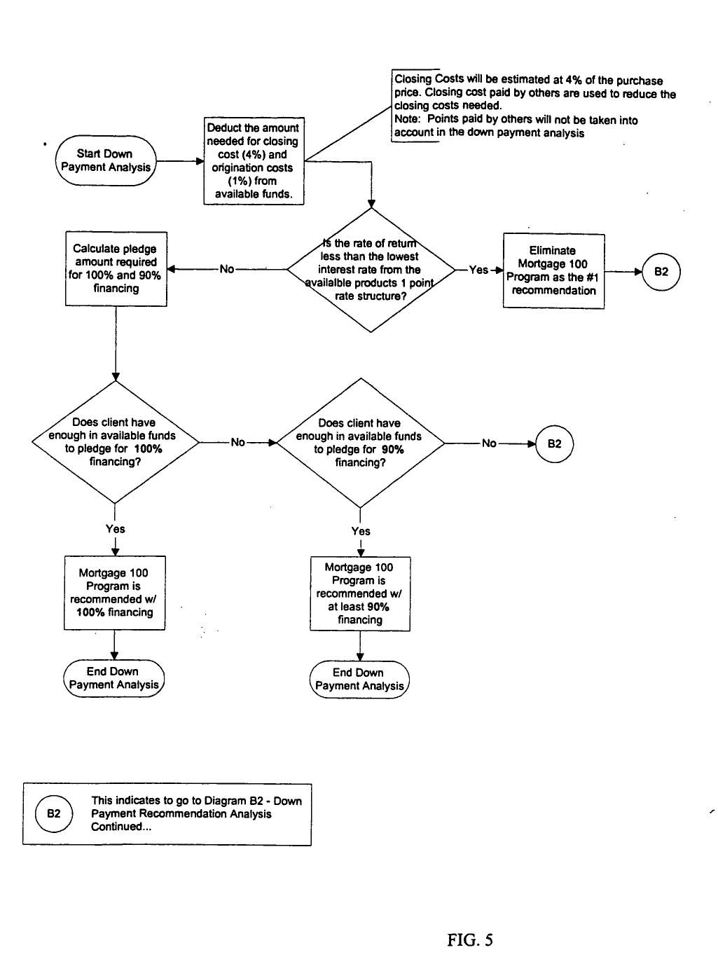

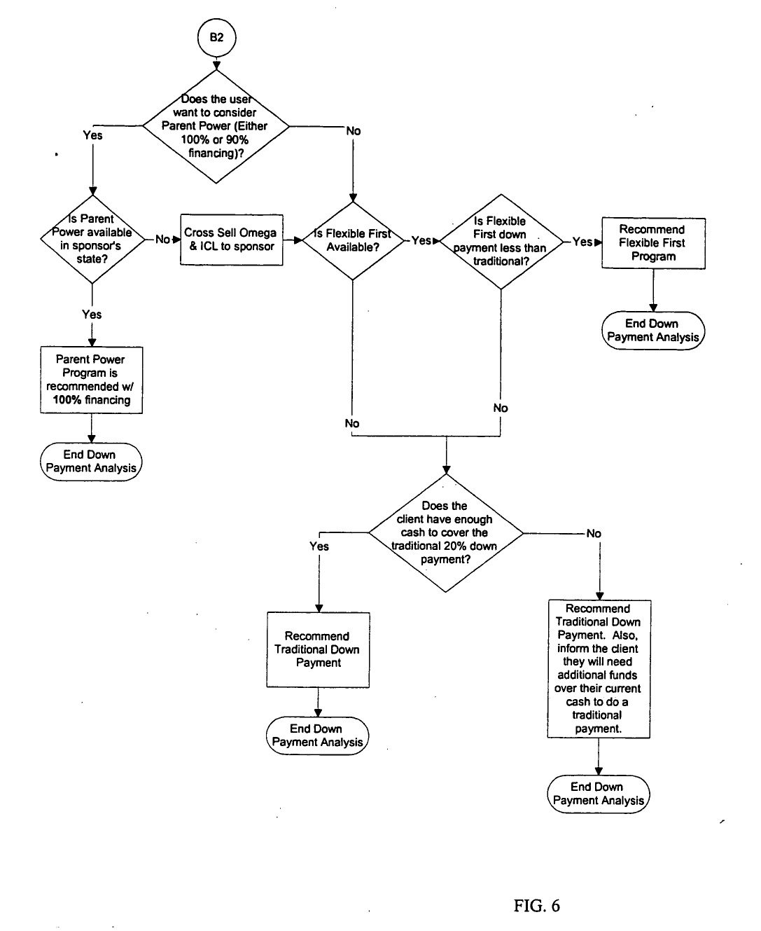

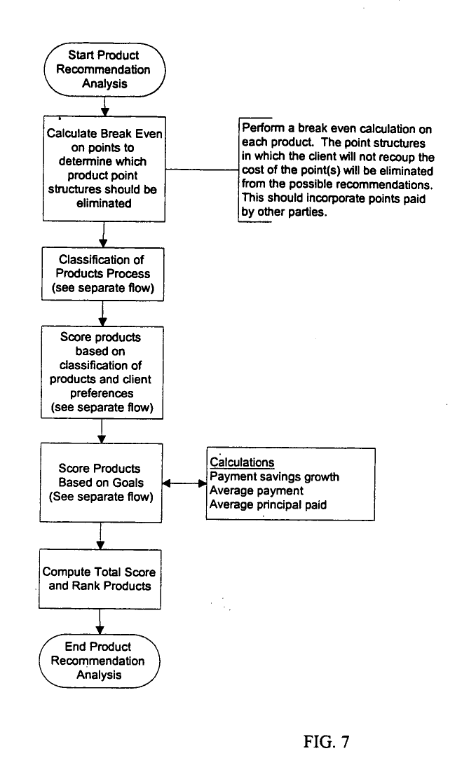

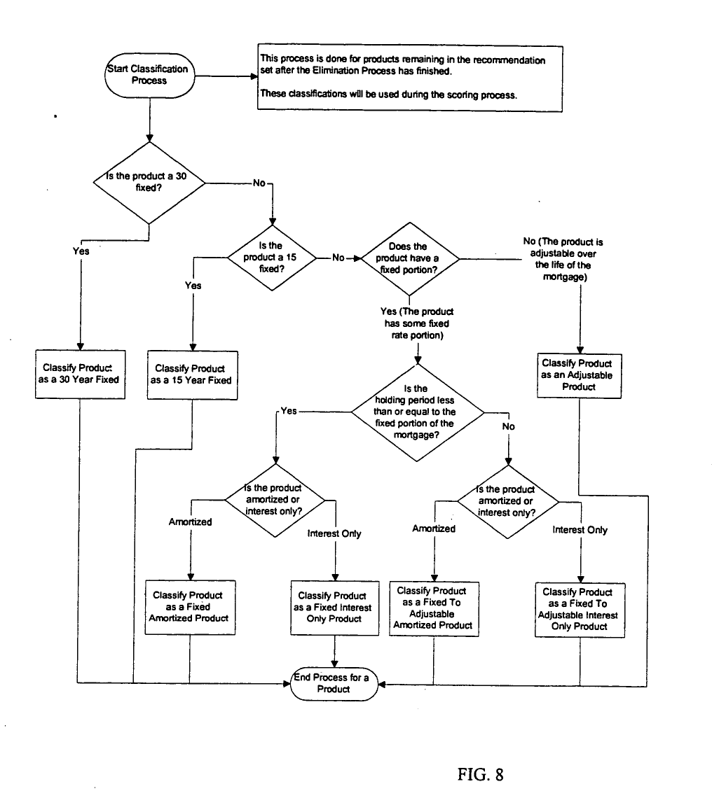

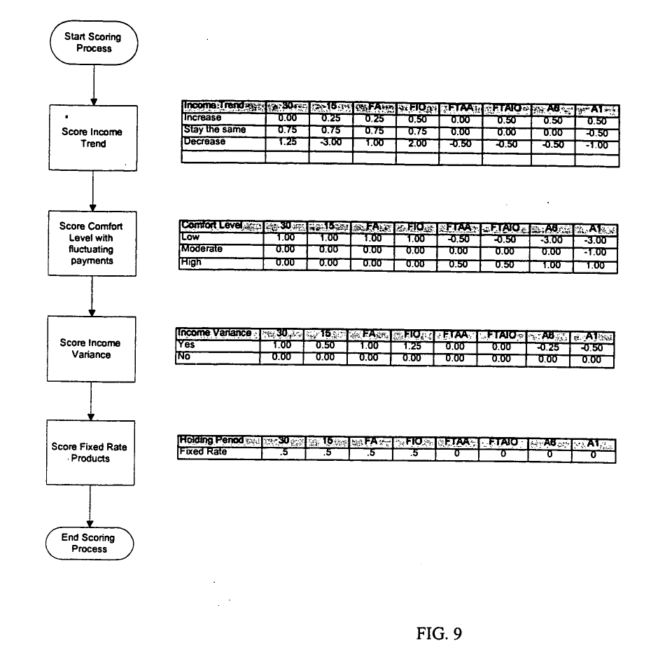

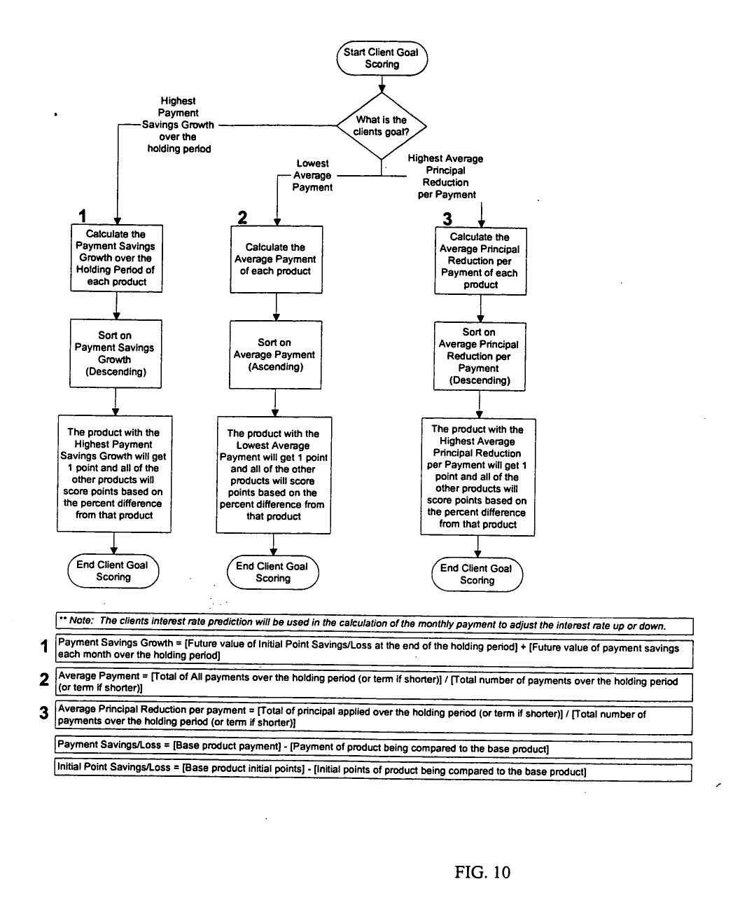

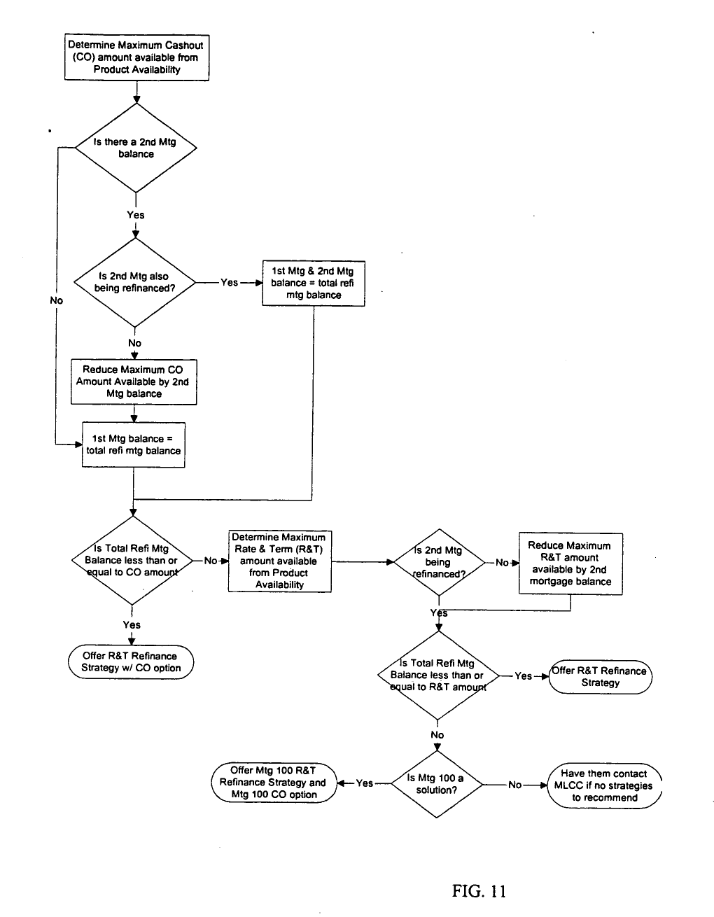

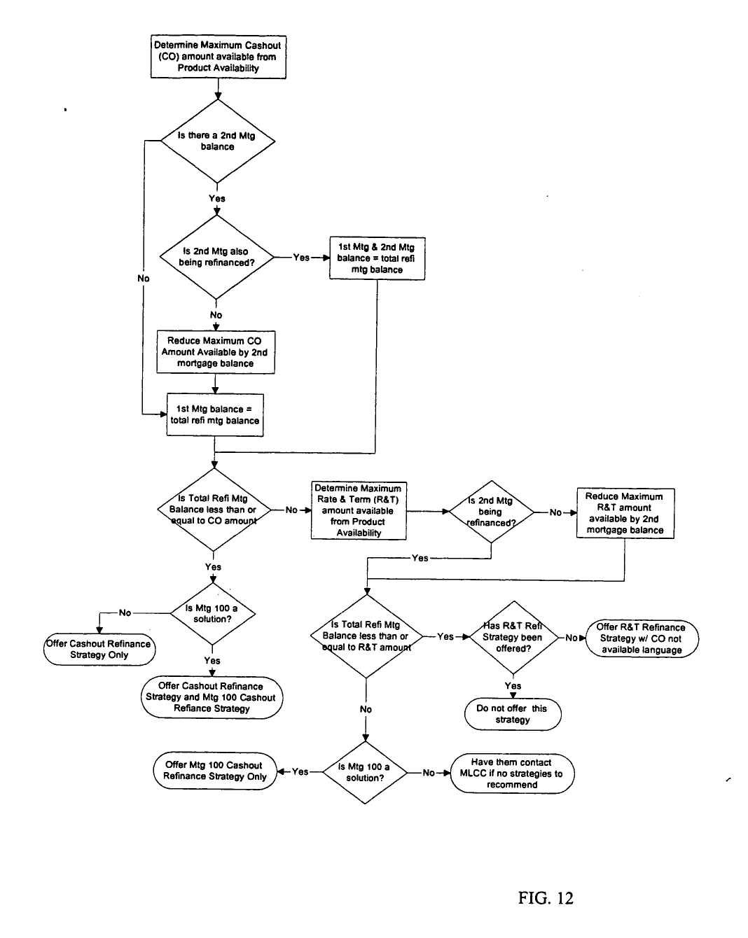

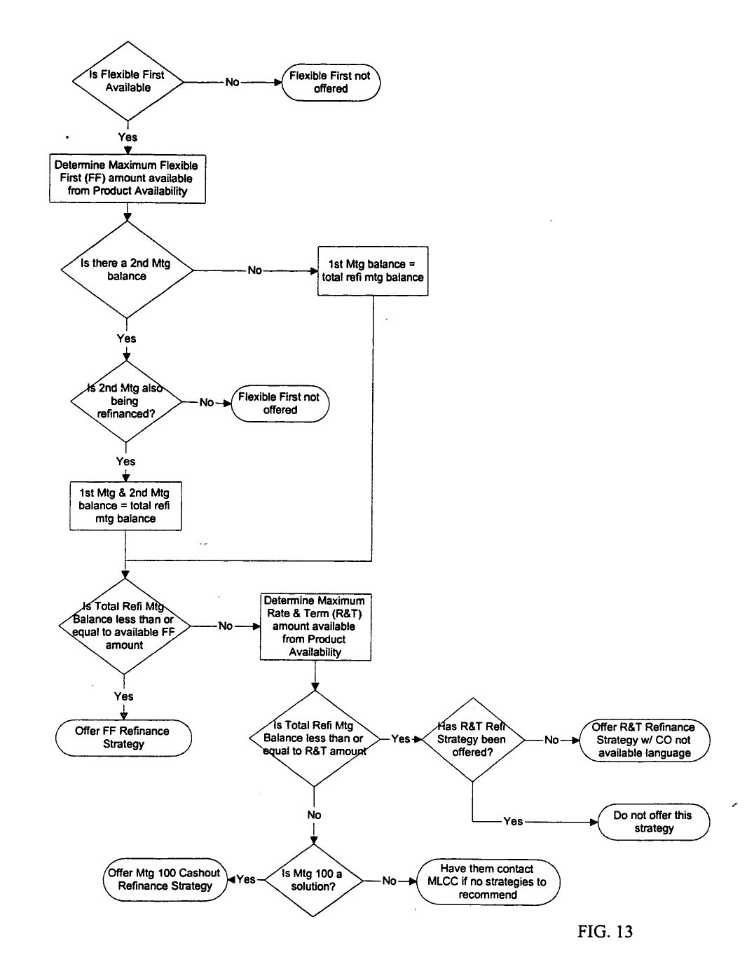

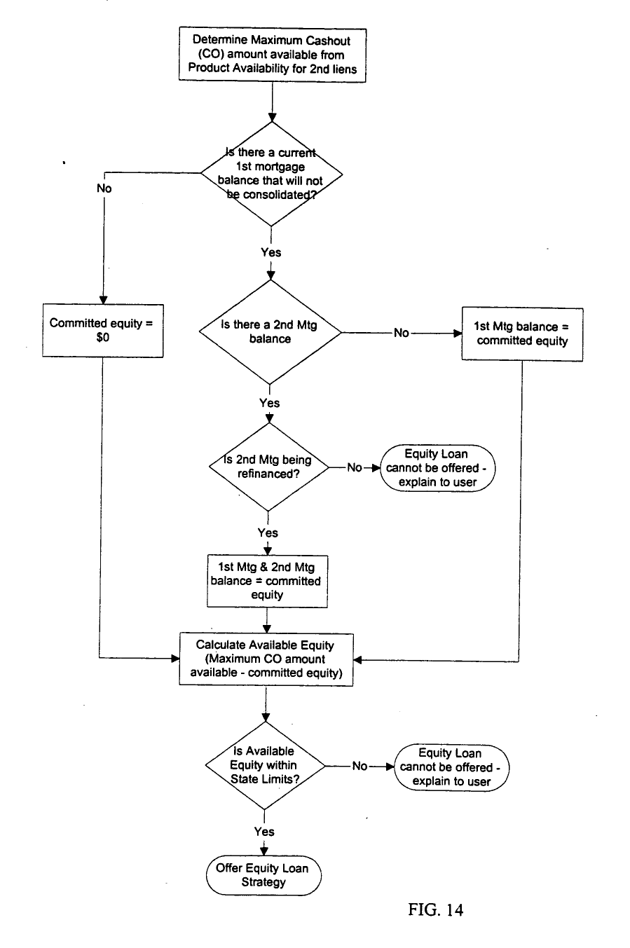

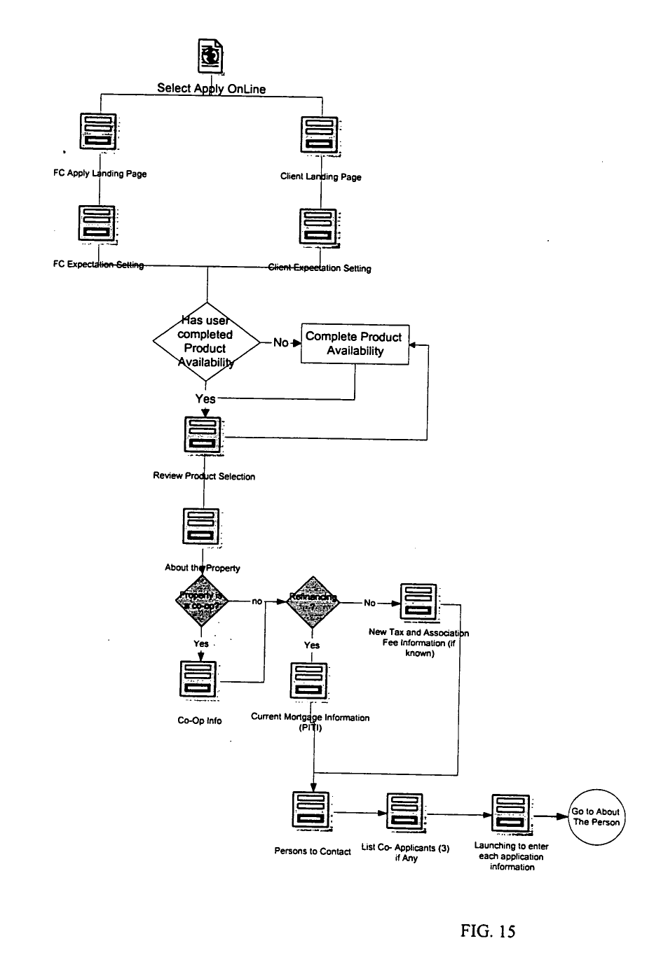

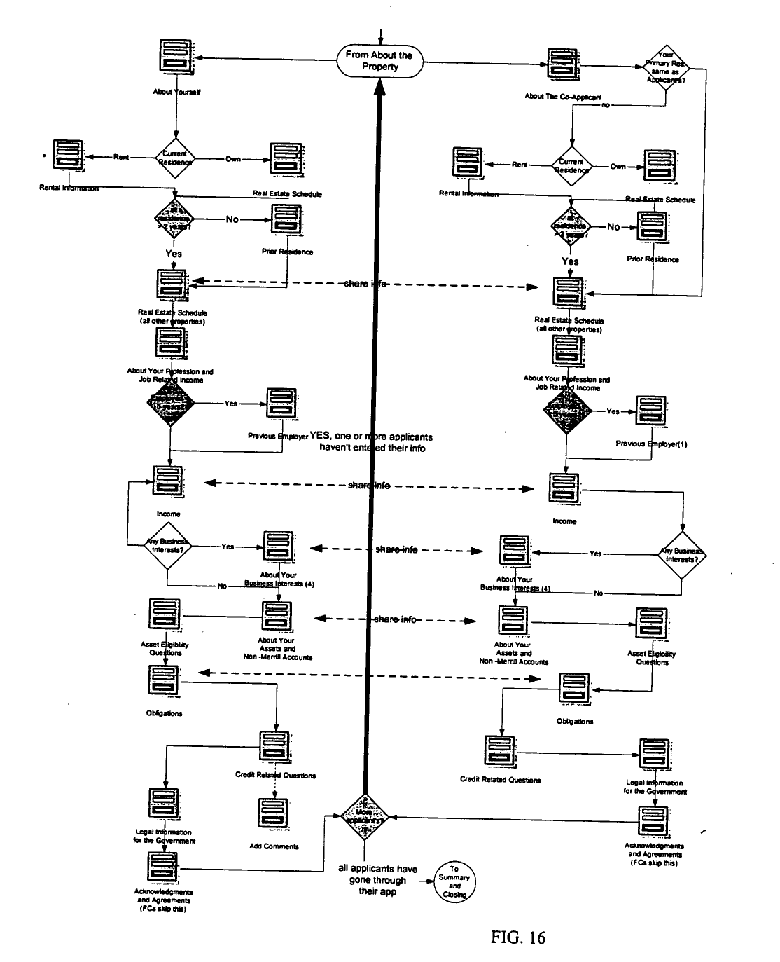

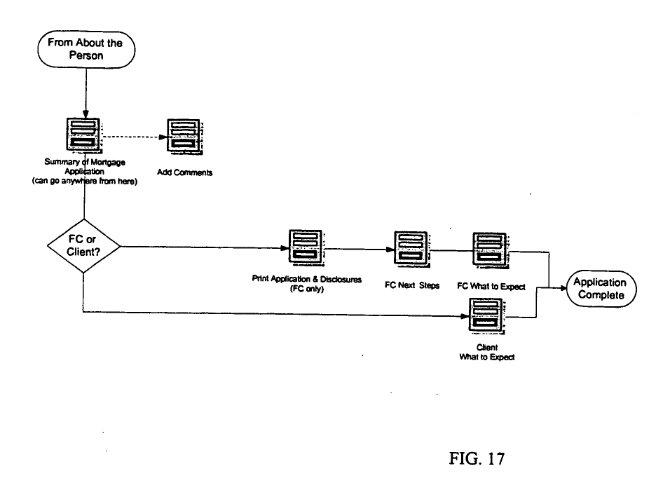

Reference is now made to FIG. 2, which contains a diagram showing selected product offerings in the exemplary Credit Advisor system. This section of the site is designed to provide helpful information to the user about the MLCC loan process. Static content in this section presents an overview of what the user can expect during the loan application process, as well as what he/she can do to prepare for the process, and is organized into the following categories:

Mortgage/home equity

Construction

Security-based credit

Additionally within this section, the user will find links to Frequently Asked Questions and a Glossary.

The Mortgage/Home Equity Loan Process preferably contains a page on each of the following steps in the loan origination process:

Step 1. Apply for your loan.

Step 2. Submit the application for review.

Step 3. Receive the welcome package.

Step 4. Reports are ordered and received.

Step 5. A credit decision is made.

Step 6. Your closing is scheduled.

Step 7. The loan is closed and funded.

The Construction Loan Process contains a page on each of the following steps in the construction to permanent loan process:

Step 1. Apply for your loan.

Step 2. Submit the application for review.

Step 3. Receive the welcome package.

Step 4. Reports are ordered and received.

Step 5. A credit decision is made.

Step 6. Your closing is scheduled.

Step 7. The loan is closed.

Step 8. Build your home.

Step 9. The modification process takes place.

The Security Based Credit Process contains a page on each of the steps below to establish an OMEGA line of credit:

Step 1. Complete the application.

Step 2. Submit your application for review.

Step 3. Return your loan documents.

Step 4. Your loan account is activated.

A link is also provided that instructs the user to contact his/her Financial Consultant if interested in establishing an Investor Credit Line or Flexible Credit account.

One function of the Credit Advisor system is to allow the an FC user to recommend the right product and program for the client based on pertinent questions asked about the client's needs and financial situation. Once a product is recommended, the user may be view current interest rates, payments and closing costs for the recommended product. Aspects of the Credit Advisor site include:

Product Availability: The user will be given a list of available MLCC products based on factors such as: property state, property type, occupancy status, property value and loan amount requested.

Home Finance Advisors: Using the Home Purchase or Home Refinance Advisor tools, factors such as how long the client will be in his/her home, the client's perception of the interest rate environment, his/her investment strategies and other personal preferences are used to recommend specific MLCC mortgage products and programs.

Loan Details: The user will be given access to real-time MLCC's mortgage rates, points and APRs. Estimated MLCC closing costs are provided, based on factors such as the property value, location, characteristics and the loan amount requested. Also, if the Mortgage 100 or Parent Power program is selected, pledge account requirements are provided.

Application Submission and Disclosure Printing: The online application section of the site allows the user to electronically submit a subset of the FNMA 1003 mortgage application to MLCC. The application submission screens capture the required information necessary to begin the loan process. If the user is an FC or CA, once the mortgage application is complete and before it can be submitted to MLCC, they must locally print the required state and federal disclosures from the site.

This functionality also provides Lending Services with the ability to search and retrieve applications submitted via the web site in order to assist the user in completing the application prior to submission, or to begin processing the application once it has been submitted.

Accessing Saved Sessions and Account information: A Client and/or his/her FC may selectively access the most current information on a mortgage loan in process or servicing with MLCC. Users may also access previously saved Credit Advisor and Online application sessions.

Supporting Functionality: Supporting functionality within the site offers the user access to company information about MLCC and the ability to submit feedback electronically about the web site and MLCC. Additionally, the user is provided with access to a glossary of terms found throughout the web site and answers to frequently asked questions.

MLCC Loan Process: This section is designed to provide helpful information to the user about the MLCC loan process. Static content in this section presents an overview of what the user can expect during the loan application process, as well as what he/she can do to prepare for the process. Additionally, within this section, the user will find links to the Frequently Asked Questions and the Glossary.

MLCC Products and Programs: The products section of the site contains pages discussing MLCC's products and services enabling the user to understand the different s benefits of MLCC's products and programs, and to choose which loan is best for his/her needs. From this section of the site, the user may also access PDFs of current MLCC sales materials and a mortgage application.

FC Landing Page: The FC Landing page is specifically designed for FCs, who access the site through a secured network connection. When an FC enters the site through this landing page, he/she will be provided with links back to areas in the secured network that contain liability information, such as a Product & Service module and a Learning Channel. Additionally, on this page the FCs are provided with important compliance and sales information.

Lending Services Functionality: The Lending Services landing page provides Loan Consultants, Loan Officers, Application Coordinators and Team Leaders with direct links to various internal resources, such as sections of the Mortgage and Credit Solutions and InSite web sites, as well as additional MLCC internal partner functionality.

Legal & Compliance: In order to meet compliance and legal requirements the following disclosures are incorporated throughout the web site:
payment and rate disclosures;
privacy policy;
important loan cost disclosures; and
MLCC licensing information.

Payment & Rate Disclosures: These disclosures preferably include at least the following:

1. Payment After Interest-Only Period:
Any time an interest-only payment is quoted for a product, the following information must be available via a hyper-link:
   Interest-only term;
   Initial amortizing payment based on current interest rates.

2. Payment After Fixed Rate Period:
Any time a fixed-to-adjustable payment is quoted for a product, the following information must be available via a hyper-link:
   Current interest rate for the fixed period;
   Fixed period;
   Adjusted rate basis (index and margin);
   Adjusted rate based on current interest rates;
   Adjusted payment based on estimated adjusted rate.

3. Interest Rate Quotes:
Any time an interest rate is quoted for a product, an APR must also be provided based on the current rate and the actual loan amount. Additionally, the following statement must be footnoted at the bottom of the page:
   “Due to market fluctuations, rates are subject to change at any time. The client's rate cannot be locked until a Loan Consultant reviews the loan application and a rate lock fee is collected. Certain products/programs may not be eligible for the upfront rate lock option.”

4. Privacy Policy:
At the top of each page within the site, the user can access the Privacy Policy link, which will take them to the following statement of Merrill Lynch's privacy policy:
   “Merrill Lynch is as concerned as you are about the privacy of any personal information that you may provide to us. We have rigorous safeguards and practices in place to protect client privacy, and under no circumstances do we sell our clients'names or personal information to non-Merrill Lynch companies.
      When you visit the Merrill Lynch Credit Corporation (MLCC) web site:
         You are not required to provide any personal information unless you choose to do so. Our Web server will recognize your domain name, but not your e-mail address.
         We currently use cookies to provide personalized information specific to your needs. Our Web server will record the pages you visit within the Merrill Lynch Credit Corporation web site, but such information will be used only for our own marketing and/or research and development purposes, or otherwise in connection with servicing your financial needs. These cookies are temporary in nature and do not reside on your computer past the life of your browser session.
         If you request information about our products and services, you may voluntarily provide additional personal information, such as your occupation, age, gender, income, marital status, etc. This information will be used for evaluating your financial needs and for our own marketing and/or research and development purposes.
         We will not transfer your personal information to any non-Merrill Lynch entity for commercial purposes. You may be contacted by a Merrill Lynch Financial Consultant to follow up on your interest in our products and services.
         For purposes of this notice, ‘Merrill Lynch’ includes Merrill Lynch, Pierce, Fenner & Smith Incorporated and its corporate affiliates. You can write to Merrill Lynch Credit Corporation at MLCC, Attn: Client Liaison Department, 4802 Deer Lake Drive East, Jacksonville, Fla. 32246-6484.”

5. Important Loan Cost Disclosures:
A link is provided at the bottom of each page within the site that will take the user to the Important Loan Cost Disclosures page. On this page, the user is provided with static examples of the following items for a $300,000 loan amount on a first mortgage:
   Mortgage Product;
   Term;
   Rate & APR;
   Number of Monthly Payments;
   Monthly Payment Amount;
For the Flexible First program, an example is provided of the following information for the equity line of credit portion:
   Term;
   Application Fee;
   Origination Fee;
   Annual Fee;
   Rate & APR;
   Maximum APR.
An example with the information above is also provided for a $50,000 home equity line of credit and an Omega Account. A monthly payment is also quoted in the Omega example.
For a fixed-rate home equity loan, the following information is quoted:
   Term;
   Origination Fee;
   Rate & APR;
   Number of Monthly Payments;
   Monthly Payment Amount;

6. MLCC Licensing Information:
A link is provided at the bottom of each page within the site that will take the user to the MLCC Licensing Information page. On this page, the following licensing information must be provided:
   “Programs, options and property types are not available in all states and are subject to change. Certain conditions, restrictions and costs may apply. All mortgage programs are offered and funded by Merrill Lynch Credit Corporation (‘MLCC’) or an affiliated company, 4802 Deer Lake Drive East, Jacksonville, Fla. 32246-6484. Georgia Mortgage Lender License; Illinois is Residential Mortgage Licensee; Rhode Island Lender License; Licensed Lender License—New Jersey Department of Banking and Insurance; New York Mortgage Banker License No. 03524—New York State Banking Department; California Real Estate Broker's License No. 00831469—California Department of Real Estate (916) 227-0931; Arizona License BK10071; New Hampshire First Mortgage Banker License No. 5448-MB—Office of the Bank Commissioner; Massachusetts Small Loan Lender License No. SL0204.
      The Omega Account is offered by MLCC pursuant to California Finance Lender License No. 6030131—California Department of Corporations.
      In Arkansas, Ohio and Washington, Merrill Lynch Bank USA may fund Equity Access® and Equity Access® Prime accounts.
      With respect to MLCC's 100% financing and securities-based programs, should the value of the securities pledged as collateral decrease below a certain level (as specified within the loan documents), the deposit of additional assets and/or liquidation of assets may be required. Securities must be maintained in a brokerage account at Merrill Lynch, Pierce, Fenner & Smith Inc.—Member SIPC.
      Equity Access, Equity Access Prime, Investor CreditLine, Parent Power, PrimeFirst, Flexible First, Mortgage 100, Omega, Self-Directed Mortgage and Merrill Lynch CreditAdvisor are service marks of Merrill Lynch & Co., Inc.
   SECONDARY MORTGAGE LENDER.”

Turning attention now to the Product Availability section of the site, this section allows a user to determine all the MLCC mortgage products and programs that are currently available for a specific scenario, as well as current interest rates, payments and closing costs for a selected product.

Determining Available Products: In order to obtain a list of available products and programs, the user must provide the following information for their specific scenario:

1. Merrill Lynch client type indicator:
Priority Client Service;
MLUA Service with CMA or CBA;
MLUA Service with all other accounts;
Merrill Lynch Bank & Trust Account with $90,000 or more on deposit.

Below is the logic used to assign a client type based on the Merrill Lynch services indicated. If a user is not a client, the client type is PXXX for product availability and for the application. If the user is a client, the table below is used to determine the client type.

| | | | MLB&T Acct | | |
|---|---|---|---|---|---|
| | | | w/$90,000 | Product | |
| Priority Client | UA Service w/ | UA Service w/ | plus on | Availability | Application |
| Account | CMA or CBA | other accounts | deposit | Client Type | Client Type |
| | | | | GXXX | GXXX |
| | | | X | GXXX | BXXX |
| | | X | | GXXX | GXXX |
| | | X | X | GXXX | BXXX |
| | X | | | GXXX | MXXX |
| | X | | X | GXXX | LXXX |
| | X | X | | GXXX | MXXX |
| | X | X | X | GXXX | LXXX |
| X | | | | GXXX | KXXX |
| X | | | X | GXXX | KXXX |
| X | | X | | GXXX | KXXX |
| X | | X | X | GXXX | KXXX |
| X | X | | | GXXX | JXXX |
| X | X | | X | GXXX | JXXX |
| X | X | X | | GXXX | JXXX |
| X | X | X | X | GXXX | JXXX |

In addition, the following Client Type Rules apply:
If Priority Services selected, application fees are $0.
If Merrill Lynch Bank & Trust Account with $90,000 or more on deposit selected, application fees are $0.
If Unlimited Advantage Service with CMA or CBA selected, then MLUA discounts is/are applied to closing costs.
If Unlimited Advantage Service with all other accounts selected, then MLUA discounts is/are not applied to closing costs.

2. Merrill Lynch employee indicator: If Employee=“Yes”, then employee rates should be displayed and standard origination fee is ½% instead of 1% for non-employees.

3. US citizen or resident alien indicator: If “Are you a US Citizen or Resident Alien (Green Card Holder)?”=“No”, then the user is informed that MLCC does not currently offer products on our web site for clients who are not US Citizens or Resident Aliens (green card holders). Such users are then instructed to call a Loan Consultant.

4. Transaction purpose: The following options are provided:
Purchase of a new property;
Refinance existing mortgage(s) only;
Refinance existing mortgage(s) and receive additional cash;
Establish a second mortgage or line of credit;

5. Property state (self-explanatory).

6. Property type: The following options are provided:
Single family home;
Condominium, town house;
Attached garden/patio home;
Co-Op (New York only);
Multi-family (2-4 units);
Commercial use (Multi-family greater than 4);
   If the commercial use property type is selected, the user is taken to a page where they are informed that Merrill Lynch currently does not offer commercial real estate products online. A link to the commercial products overview section is provided and the option is provided to call a Loan Consultant for more information.

7. Occupancy status: (How will the property be used):
Primary residence;
Secondary home/vacation home;
Residential investment property;
Commercial investment property;
   If the commercial investment property occupancy status is selected, the user is taken to a page where they are informed that Merrill Lynch currently does not offer commercial real estate products online. A link to the commercial products overview section is provided and the option is provided to call a Loan Consultant for more information.

8. County where the Property is located.

9. If a purchase, what is the purchase price?
If the value provided is greater than $2 million, the user is taken to a page where he/she is informed that properties over $2 million require special handling and is instructed to call a Loan Consultant for more information.

10. If a refinance, what is current market value and current mortgage balances?
If the current market value provided is greater than $2 million, the user is taken to a page where he/she is informed that properties over $2 million require special handling and is instructed to call a Loan Consultant for more information.

11. If establishing a second mortgage, what is current market value and current first mortgage balance?

Product & Rate Filters: The user, based on the following criteria, can filter available products and their corresponding interest rates:

1. Loan amount option to view:
Products with a specific loan amount;
Maximum loan amount available based on:
   Standard maximum loan amounts;
   Requiring a pledge of eligible securities.

2. Interest rates and points to display based on users' needs:
Lowest possible interest rate for each product;
Lowest number of points for each product;
User specified number of points;

3. Type of loan interested in viewing:
Fixed-rate;
Adjustable-rate;
Fixed-to-adjustable rate;
Fixed-to-adjustable interest only;

Product & Program Display Fields: Once the user has provided the information above, he/she will be presented with a list of all of the products currently available for his/her specific situation. For each product displayed, the following information is preferably provided:

1. Product and program name;

2. Down payment amount (if a purchase transaction);

3. Loan amount;

4. Current interest rate;

5. APR;

6. Points;

7. Initial monthly payment;

8. Link to Loan Detail for this product; and,

9. Link to the Apply landing page for this product.

Each product will be displayed within the loan category into which it falls, such as:
Fixed-rate;
Adjustable-rate;
Fixed-to-adjustable rate; or,
Fixed-to-adjustable interest only.

Within each category, the products can be sorted by clicking on the following column headings:

1. Product and program name;

2. Down payment amount;

3. Loan amount;

4. Current interest rate;

5. APR;

6. Points;

7. Initial monthly payment.

The user can also limit the products displayed on the page, based on the following information:
Loan amount;
Points;
Loan type.

Flexible First Availability: If Flexible First is available for the user's scenario, a link is displayed that allows the user to view first mortgage products combined with a home equity based line of credit. For each Flexible First combination available, the following information is provided:

1. Product and program name;

2. Maximum combined loan amount;

3. First mortgage loan amount;

4. Equity line amount;

5. Initial combined monthly payment;

6. Link to Loan Detail for this combination;

7. Link to the Apply landing page for this product and program combination.

Loan Detail: For each available product and program within the Product Availability section, Home Purchase Advisor or Home Refinance Advisor, the user has the ability to access detailed loan information. On this page the user will find the following information:

Product and program display name;

Application fee—if applicable;

Purchase price or current market value;

Required cash down payment—displayed for purchases only;

Total loan amount.

If the program is Flexible First, the following additional fields are displayed:

First mortgage amount;

Home equity line of credit amount;

Link to change first mortgage and line of credit amount.

Security Pledge Account Requirements: This section is only displayed to the user if the program is Mortgage 100 or Parent Power. The fields below are dynamically calculated based on the loan amount, product and property state:

Initial security account required;

Minimum account maintenance level.

Monthly Payment and Interest Rate Information: The following information is provided for the product selected:

Principal portion of initial payment;

Interest portion of initial payment;

Total initial monthly payment;

Current interest rate;

Total points;

APR (Annual Percentage Rate);

Link to Other Rate Options for this product, where the following information is displayed for each available rate option;

Total points (origination & discount);

Cost of points;

Interest rate;

APR;

Initial monthly payment;

Years to recoup points (break-even).

If the product has an adjustable rate, the following additional information is provided:

Adjustable rate index (e.g., Prime rate, 1 month LIBOR, etc.);

Margin added to index;

Maximum lifetime rate.

If the program is Flexible First, the following additional information is displayed:

First Mortgage Information:
Total payment;
Principal portion;
Interest portion;
Current interest rate;
Points;
APR;
If adjustable—adjustable rate information;
Link to Other Rate Options for this product;

Home Equity Line Information:
Total payment;
Principal portion;
Interest portion;
Current interest rate;
Points;
APR;
If adjustable—adjustable rate information.

APR Calculation: An actual Annual Percentage Rate (APR) is calculated for each available product based on the following inputs:
Loan amount;
Points;
Payment schedule;
MLUA discount;
Closing Fees.

An exception to the APR calculation exists for all Equity Access and Fixed Rate Second products. When the product is a member of the Equity Access or Fixed Rate Second group, the APR always equals the current interest rate.

The following estimates are used for closing fees. For compliance reasons, actual fees obtained from the closing cost tables must be used in this part of the calculation as soon as these fees are accessible in the new closing cost system. The estimated fees are:

Tax service fee—$80;

Flood certification fee—$18;

Mortgage broker fee—$0;

Underwriting & Doc Prep fee—$400;

Attorney/closing agent fee—which may be approximated (for the APR calculation) based on the property state and loan amount ranges. See the following table:

| | | Loan Amounts greater than |
|---|---|---|
| | Loan Amounts less than or | $750,000, but less than |
| Property State | equal to $750,000 | $2,000,000 |
| AL | $385 | $385 |
| AK | $475 | $2125 |
| AZ | $475 | $475 |
| AR | $275 | $275 |
| CA | $475 | $1600 |
| CO | $350 | $350 |
| CT | $550 | $550 |
| DE | $385 | $385 |
| DC | $485 | $485 |
| GA | $485 | $485 |
| HI | $610 | $610 |
| ID | $475 | $475 |
| IL | $335 | $335 |
| IN | $250 | $250 |
| IA | $150 | $150 |
| KS | $250 | $250 |
| KY | $285 | $285 |
| LA | $150 | $150 |
| MA | $550 | $550 |
| MD | $485 | $485 |
| ME | $350 | $350 |
| MN | $360 | $360 |
| MI | $460 | $460 |
| MO | $325 | $325 |
| MS | $150 | $150 |
| MT | $325 | $325 |
| NE | $300 | $300 |
| NV | $214 | $1603 |
| NH | $435 | $435 |
| NJ | $300 | $300 |
| NM | $475 | $475 |
| NY | $485 | $485 |
| NC | $535 | $535 |
| ND | $400 | $1150 |
| OH | $335 | $335 |
| OK | $415 | $415 |
| OR | $475 | $1600 |
| RI | $450 | $450 |
| SC | $300 | $300 |
| SD | $125 | $125 |
| TN | $285 | $285 |
| TX | $275 | $275 |
| UT | $250 | $250 |
| VA | $485 | $485 |
| VT | $385 | $385 |
| WA | $523 | $2699 |
| WV | $385 | $385 |
| WI | $310 | $310 |
| WY | $300 | $300 |

Estimated Closing Costs: The following estimated closing costs are provided for the product selected based on the loan amount, transaction type, county, property type, occupancy status and interest rate option selected:

Origination fee/points;

Appraisal fee;

Credit report;

Closing agent/attorney;

Tax service fee;

Title search/insurance;

Recording fee;

City tax/stamps;

County tax/stamps;

State tax/stamps;

Survey;

Flood zone survey;

Notary fee.

If the user indicated earlier that he/she is an MLUA client with a CMA or CBA, the following closing cost is also dynamically calculated and displayed:

MLUA Discount—(calculated at 50% of the origination fee up to $2500).

Adjustments for Flexible First Fees: When the selected program is Flexible First, the following guidelines are used when determining closing costs:

Closing Cost—Calculation;

origination fee—Based on total points paid;

Appraisal fee—Based on 1st mortgage only;

Credit report—Based on 1st mortgage only;

Closing agent/attorney—Based on 1st mortgage only;

Tax service fee—Based on 1st mortgage only;

Title search/insurance—Based on 1st mortgage only;

Recording fee—Based on 1st & 2nd mortgages;

City tax/stamps—Based on 1st & 2nd mortgages;

County tax/stamps—Based on 1st & 2nd mortgages;

State tax/stamps—Based on 1st & 2nd mortgages;

Survey—Based on 1st mortgage only;

Flood zone survey—Based on 1st mortgage plus $5;

Notary fee—Based on 1st mortgage only.

Estimated Prepaid Fees: The following estimated prepaid fees are calculated and displayed for the product selected based on the loan amount, property type, property state and interest rate option:

Prepaid interest (30 days);

Hazard insurance reserve;

Property tax reserves.

The following tables outline the calculations for each fee based on the property type:

If Property Type is a Single Family or Multi-Family

| | California | All other States |
|---|---|---|
| Prepaid interest | 30 days | 30 days |
| Property taxes | 6 months (.005 of | 6 months (.01 of |
| | Property Value) | Property Value) |
| Hazard insurance | 12 months (.0035 | 12 months (.0035 |
| | of Loan Amount) | of Loan Amount) |

If Property Type is Condominium, Townhouse or Attached PUD

| | California | All other States |
|---|---|---|
| Prepaid interest | 30 days | 30 days |
| Property taxes | 6 months (.005 of | 6 months (.01 of |
| | Property Value) | Property Value) |
| Hazard insurance | $0 - N/A | $0 - N/A |

If Property Type is co-op

| | New York | All other States |
|---|---|---|
| Prepaid interest | 30 days | $0 - N/A |
| Property taxes | $0 - N/A | $0 - N/A |
| Hazard insurance | $0 - N/A | $0 - N/A |

Payment Schedule: A detailed payment schedule can be accessed for a specific product. This schedule will show the user the amount of principal and interest he/she will be paying each month on his/her loan, as well as the outstanding loan amount after each payment is made. The following fields are displayed for each month over the term of the loan:

Payment month;

Interest rate;

Monthly payment;

Interest;

Principal;

Additional payment;

Loan balance;

If the user would like to see how his/her payments and loan balance would be affected by making additional payments towards principal at any time over the life of the loan, the user can add additional principal payments to this schedule using the Add Pre-Payment button. By providing the information below, the user can recalculate the payment schedule to see how the monthly payments and loan balance are affected by making additional principal payments. The required inputs are:

Total number of additional principal payments the user would like to make;

The amount of additional principal the user would add to the normal monthly payment;

The payment number at which the additional payments would like to start;

The frequency at which the user would make these additional payments—entered as either months or years.

Once the user defines the additional prepayments, the system can recalculate the payment schedule to reflect the new figures.

Home Purchase Advisor: Shifting focus, now, to the Home Purchase Advisor aspects of the invention, this part of the system is used to guide the user through a series of questions designed to gather information about his/her individual situation and then complete an analysis that recommends the MLCC product and program that is right for his/her needs. The Home Purchase Advisor includes the following three components:
Product and program availability;
Down payment strategy recommendation;
Product scoring and recommendation.

Product & Program Availability: In order to obtain a list of available products and programs to use in an advisory session, the following availability information is gathered from the user:

1. Merrill Lynch client indicator;

2. Merrill Lynch employee indicator;

3. US citizen or resident alien indicator;

4. Purchase price of property;

5. Property state;

6. Property type:
Single family home;
Condominium, town house;
Attached garden/patio home;
Co-op (New York);
Multi-family (2-4 units);
Commercial use (Multi-family greater than 4);

7. Occupancy status:
Primary residence;
Secondary home/vacation home;
Residential investment property;
Commercial investment property;

8. County where the property is located.

Down Payment Recommendation Logic: Once the available products and programs are determined, the Purchase Advisor first asks a series of questions to determine the amount of funds the client has available for use as part of his/her down payment strategy. Funds available from the following sources are gathered:

Source 1: Current value of non-retirement securities;

Source 2: Amount of non-retirement securities that are already being used as collateral to secure a loan or line of credit (e.g., a margin or pledge);

Source 3: Cash currently available in checking, savings and asset accounts, that can be used towards the mortgage transaction;

Source 4: Funds available from the sale of another property (Note: This figure is only used in the available funds calculation if the user indicates that the property will be sold prior to the closing of the new loan);

Source 5: Closing costs paid by other parties;

Source 6: Funds available from a gift.

The advisor uses the following formula to determine the amount of total down payment funds available:
Total funds available=(Source 1−Source 2)+Source 3+Source 4+Source 5+Source 6.
The advisor then deducts estimated closing costs (estimated at 4% of the purchase price) and the cost of the points to calculate the funds available for a pledge, as follows:
Funds available for pledge=Total funds available−4% closing cost estimate−cost of points.

If the user indicates that someone else will be contributing toward his/her closing costs, the funds contributed are used to reduce the 4% closing cost estimate before the Funds available for pledge is calculated.

An initial pledge amount is calculated based on the purchase price. If the client has sufficient funds to cover the initial pledge, then Mortgage 100 (100% financing) is added as a down payment strategy recommendation. If not, another pledge amount is calculated based on 90% of the purchase price. If the client has sufficient funds to cover the 90% pledge, then Mortgage 100 with 90% financing is added as a down payment strategy recommendation.

If the Parent Power program is available in the property state and Mortgage 100 is not one of the recommended down payment strategies, the user is asked if he/she is interested in having someone in his/her immediate family pledge non-retirement securities. If he/she is interested in Parent Power, the sponsor's state is collected. If the sponsor's state is an approved Parent Power state, the user is provided with descriptive information and asked if he/she would like to add Parent Power as a possible down payment strategy for his/her situation.

The following information is displayed for loan to values of 100%, 95%, 90% and 85%:
Loan amount;
Loan to value percentage;
Cash down payment required;
Initial security pledge requirements.

If the Parent Power sponsor state is not an approved state, a cross-sell opportunity is presented whereby the sponsor can use the OMEGA account or Investor Credit Line account to leverage the securities to provide the user with funds for closing.

If the Flexible First program is available in the property state, it is added as a possible down payment strategy recommendation as well. A traditional down payment is also added as a possible recommendation.

The result is a list of strategies, and the first available strategy is recommended to the user based on the following priority:

1. Mortgage 100 with 100% financing (If available and rate of return is acceptable);

2. Mortgage 100 with 90% financing (If available and rate of return is acceptable);

3. Parent Power (If available and user is interested);

4. Flexible First (if available) or a traditional down payment, based on which provides the largest loan amount.

If the traditional or Flexible First strategy is recommended, but the user does not have enough in available funds to cover the down payment, then special language is displayed that recommends the user contact a Loan Consultant to explore other financing options. This would give the Loan Consultant an opportunity to discuss mortgage insurance.

The user is also provided with a list of the other available down payment strategies. He/she can select one of these strategies, instead of the recommended strategy, and reduce the loan amount requested before proceeding to the product recommendation section.

Down Payment Strategy Comparisons: Once a down payment strategy is recommended to the user, the user is given the ability to compare it to other available strategies, or over-ride it and continue with one of the other available strategies. The down payment comparison provides the user with a side-by-side comparison of the available strategies, based on the following factors:
Total loan amount;
Down payment percentage;
Required cash down payment;
Cash available for investing;
Initial pledge account;
Maintenance pledge account;
Invested down payment at the end of the holding period.

Down Payment Strategy Benefits: For each down payment strategy recommended, the user has the ability to see how such strategy would benefit him/her based on their specific situation.

Mortgage 100 Benefits: In this section, the user is shown a comparison between a loan with a traditional down payment versus a loan using the Mortgage 100 program. The comparison is based on the same factors identified in the previous section. The user is also given an estimate of the initial and maintenance pledge account requirements, as well as the ability to calculate the amount of pledge required for a different loan amount.

Parent Power Benefits: In this section, the user is shown a comparison between a loan with a traditional down payment versus a loan using the Parent Power program. The two loans are compared based on the following factors:
Cash needed for traditional down payment;
Securities that must be liquidated for cash;
Return on liquidated securities over the holding period;
Cash needed for a Parent Power down payment;
Growth of the sponsor's initial security pledge over the holding period, assuming the following rates of return:
   5%
   7%
   10%
      The user is also given an estimate of the initial and maintenance pledge account requirements for the sponsor, as well as the ability to calculate the amount of pledge required for a different loan amount.

Flexible First Benefits Compared to a Traditional Down Payment: In this section, the user is shown a comparison between a Flexible First loan and a loan with a traditional down payment. The two loans are compared based on the following factors:
Down payment percentage;
Cash down payment;
Loan amount;
Savings at closing based on down payment amounts;
Estimated 14 months of pre-paid mortgage insurance at closing if less than a traditional down payment is made;
Estimated mortgage insurance per month if less than a traditional down payment is made.

In making these calculations, the following Mortgage Insurance Guidelines are preferably applied:

| Loan Amount | Corresponding Maximum LTV |
|---|---|
| up to $350,000 | 90.01-95% |
| up to $450,000 | 85.01-90% |
| up to $700,000 | 80.1-85% |

The monthly mortgage insurance payment is estimated by using the following calculation:
Property Value×0.0044.

Traditional Down Payment versus Mortgage Insurance: In this section, the user is shown a comparison between a traditional down payment versus a higher loan amount using Mortgage Insurance (providing that mortgage insurance is available for a higher loan amount—see Mortgage Insurance guidelines above). The two options are compared based on the following factors:
Down payment percentage;
Cash down payment;
Loan amount;
Estimated mortgage insurance required at closing;
Estimated mortgage insurance per month.

Purchase Advisor—Product Recommendation Logic: Once the user selects a down payment strategy, the advisor asks a series of questions to use in scoring the available products that can be used with the selected strategy. The following information is gathered from the user:

1. How long the user plans to own the property—holding period;

2. Income trend:
Stay the same;
Increase;
Decrease;

3. Monthly income variance:
More than 25%;
Less than 25%;

4. Preference on payment fluctuations:
No fluctuation;
Minimal fluctuation;
Frequent fluctuations;

5. Interest rate forecast:
Stay the same;
Increase gradually (¼% per year);
Increase moderately (½% per year);
Decrease gradually (¼% per year);
Decrease moderately (½% per year);
Increase then decrease gradually (¼% per year);
Increase then decrease moderately (½% per year);
Decrease then increase gradually (¼% per year);
Decrease then increase moderately (½% per year).

6. Comparison product selected from all available products;

7. Home purchasing goal:
Low monthly payment for investing the difference;
Low monthly payment, without investing difference;
Loan balance reduction.
   Based on the holding period for the property, each product is classified into one of the following categories:
30 year fixed;
15 year fixed;
Fixed amortizing;
Fixed interest only;
Fixed to adjustable amortizing;
Fixed to adjustable interest only;
6 month adjustable;
1 month adjustable.
   (For example, if the client has a 7 year holding period, the 7 and 10 year interest only product will be classified as fixed interest only and the 5 year interest only will be classified as Fixed to adjustable interest only.)

Once all the available products are classified, each product is scored based on its classification and the information the user provided for his/her income trend, income variance, and comfort level with payment fluctuations. The following matrix summarizes how each product will score points based on the user's answers to the questions:

| | 30 | 15 | FA | FIO | FTAA | FTAIO | A6 | A1 |
|---|---|---|---|---|---|---|---|---|
| Income | | | | | | | | |
| Trend | | | | | | | | |
| Increase | 0 | 0.25 | 0.25 | 0.5 | 0 | 0.5 | 0.5 | 0.5 |
| Stay the | 0.75 | 0.75 | 0.75 | 0.75 | 0 | 0 | 0 | −0.5 |
| same | | | | | | | | |
| Decrease | 1.25 | −3 | 1 | 2 | −0.5 | −0.5 | −0.5 | −1 |
| Comfort | | | | | | | | |
| Level | | | | | | | | |
| Low | 1 | 1 | 1 | 1 | −0.5 | −0.5 | −3 | −3 |
| Moderate | 0 | 0 | 0 | 0 | 0 | 0 | 0 | −1 |
| High | 0 | 0 | 0 | 0 | 0.5 | 0.5 | 1 | 1 |
| Income | | | | | | | | |
| Variance | | | | | | | | |
| Yes | 1 | 0.5 | 1 | 1.25 | 0 | 0 | −0.25 | −0.5 |
| No | 0 | 0 | 0 | 0 | 0 | 0 | 0 | 0 |

| | |
|---|---|
| Key | |
| 30 | 30 year fixed |
| 15 | 15 year fixed |
| FA | Fixed Amortizing |
| FIO | Fixed Interest Only |
| FTAA | Fixed to Adjustable Amortizing |
| FTAIO | Fixed to Adjustable Interest Only |
| A6 | Adjustable 6 month |
| A1 | Adjustable 1 month |

If the product is classified as a 30-year fixed, 15-year fixed, Fixed Amortizing, or Fixed Interest Only, the product will receive an additional 0.35 points.

Each product receives a score for income trend, income variance, comfort level with payment fluctuation, and if the product rate is fixed. These scores are added together to come up with 40% of the total product score.

Next, the Purchase Advisor performs calculations to come up with the remaining 60% of the total product score. The calculation performed is based on the home-purchasing goal selected by the user. If the calculation involves calculating monthly payments for the product (for payment savings or average payments), the user's forecast of interest rates is used when determining adjustable payments in the payment schedule. The system also factors in any interest rate caps when making these payment adjustments based on the interest rate forecast.

The home purchasing goals and accompanying calculations are:

| | Home Purchasing Goal | Calculation Performed |
|---|---|---|
| 1 | Low monthly payment for | Payment savings growth over the |
| | investing the difference | holding period |
| 2 | Low monthly payment, | Lowest average payment over the |
| | without investing difference | holding period |
| 3 | Loan balance | Highest principal reduction per payment |
| | reduction | over the holding period |

Payment savings growth is calculated based on the difference in the payment for the product and the payment for the base (comparison) product selected by the user. The future value of each difference is calculated based on the holding period and the investment rate-of-return the user enters. The future value of each payment savings is summed to compute a total payment savings growth over the holding period.

To calculate the total, sum the future value of all payment savings.

Lowest average payment is calculated by adding each of the payments over the holding period and dividing it by the holding period (in years) times 12.

Highest principal reduction per payment is calculated by adding the principal paid for each payment over the holding period and dividing it by the holding period (in years) times 12.

After all products have received a score based on the goal, a total score is calculated for each product by adding the total product score and the goal score together. These scores are then recalculated on a 100-point scale, with the highest possible score being 100.

The product with the highest total score is considered the “best” product. Each product's total score is then compared to the “best” product's total score and a % difference is calculated. This percentage difference is then subtracted from 100% to determine the score that is displayed to the user. For example, the “best” product will receive a score of 100% and a product that has a 20% difference from the “best” product will receive a score of 80%.

The advisor then recommends the two products with the highest scores and the base product initially selected by the user. If the base product has one of the two highest scores, then the product with the third highest score is displayed as well.

The standard one point (½ point if an ML employee) interest rate and APR is quoted on this screen to the user, unless he/she has indicated that another party will be paying points for him/her as part of this mortgage transaction. If the user has indicated that another party will be paying points, the rate option displayed is based on the standard one point plus the points paid by the other party.

From the recommendation screen the user has the ability to access a list of all available products for his/her specific scenario, do a side-by-side comparison of the recommended products, or access loan details for a specific product.

Purchase Advisor—Product Scoring Detail: If the user is part of the CreditAdvisor NT user group (limited to MLCC partners), he/she is given access to a table containing the scoring factors and results for all of the available products. This table contains the following information for each available product:
Product and program name;
Percentage score;
Total score;
Goal score;
Total product score;
Income trend score;
Income variance score;
Payment fluctuation score;
Fixed product score;
Payment savings growth;
Average payment;
Average principal reduction per payment;
Principal accumulation;
Payment savings growth and principal paid;
Interest rate;
APR;
Points;
Initial payment;
Product code.

Purchase Advisor—Product Comparison: The user has the ability to view a comparison of the top three recommended products based on the entered purchase price, estimated holding period and estimated rate-of-return. The base product initially selected by the user is used as the baseline for comparison purposes. The products are compared based on the following factors:
1. Total loan amount;
2. Down payment percentage;
3. Cash down payment;
4. Cash available for investing;
5. Initial monthly payment;
6. Interest rate;
7. APR;
8. Points;
9. Average payment over holding period;
10. Principal paid over the holding period;
11. Invested cash growth over the holding period.

The user can also add a third party product to the comparison by providing the following information on the third party product:

1. Product Type:
30-year fixed;
15-year fixed;
5-year fixed-to-adjustable;
7-year fixed-to-adjustable;
10-year fixed-to-adjustable;

2. Initial interest rate;

3. Down payment percentage:
0%;
5%;
10%;
15%;
20%;
25%;
30%;
35%;
40%.
   This third-party product is then used as the baseline for comparison purposes.

Purchase Advisor—Re-Running a Recommendation: If the user would like to change any of the information he/she provided in order to see how different answers affect the home financing recommendations, the user can access a summary screen of the information provided throughout the advisor screens. The information on this screen is divided into the sections listed below and each section header will take the user to the section of the advisor where the information can be changed:

| | |
|---|---|
| Section 1. | Purchasing a home; |
| Section 2. | Tell us about the property you plan to |
| | purchase; |
| Section 3. | What type of investor are you; |
| Section 4. | Down payment options; |
| Section 5. | Down payment strategy; |
| Section 6. | Your home financing options; |
| Section 7. | Interest rate forecast assumptions; |
| Section 8. | Choose a comparison product; |
| Section 9. | Home purchasing goals. |

When the user navigates back to a previous section using this screen, he/she must use the next button on the screen where the answer was changed to move forward through the remaining pages until the user is returned to the Home Financing Recommendation Page. This is important because, as a user changes his/her answer to a question, it could require the Credit Advisor system to collect additional information in order to make a final recommendation.

Purchase Advisor—Special Considerations: Due to the fact that a specific product is not present during the down payment strategy recommendation process and to account for different LTVs based on conforming and non-conforming products, the following rules were added to the Purchase Advisor:

1. If property type=condo, occupancy status=primary or second home, then exclude conforming products.

2. If property type=co-op, exclude conforming products.

3. If occupancy status=second home, exclude conforming products.

4. If occupancy status=investment property, a special down payment recommendation page is provided that will offer Mortgage 100 (if available based on product availability), and a traditional down payment with a conforming 15 or 30 year fixed rate mortgage.
If Mortgage 100 is selected, the user continues through the product scoring to determine the appropriate non-conforming first mortgage for his/her situation.
If the user selects the traditional down payment, he/she skips product scoring and is taken to the recommendation page for the 15 or 30 year fixed conforming products.

Home Refinance Advisor: Focus is now redirected to the home refinance aspect of the invention. The Home Refinance Advisor guides the user through a series of questions designed to gather information about his/her individual situation and then complete an analysis that recommends the MLCC product and program that is right for the user's needs. The Home Refinance Advisor consists of the following three components:
Product and program availability
Refinance strategy recommendation
Product scoring and recommendation

Product & Program Availability: In order to obtain a list of available products and programs to use in the advisory session, the following availability information is gathered from the user:
1. Merrill Lynch client indicator;
2. Merrill Lynch employee indicator;
3. US citizen or resident alien indicator;
4. Current market value of the property;
5. Property type:
   Single family home;
   Condominium, town home;
   Attached garden/patio home;
   Co-op (New York);
   Multi-family (2-4 units);
   Commercial use;
6. Property state;
7. Property county;
8. Occupancy status:
   Primary residence;
   Secondary home/vacation home;
   Residential investment property;
   Commercial investment property.

Strategy Recommendation Logic: Based on the user's response to the questions below, up to four refinance intentions are displayed. Questions used to determine possible intentions are:

1. Current balance on primary mortgage;

2. Current balance on second mortgage;

3. If second mortgage is a line of credit, the maximum line of credit available.

| Intention | | Display Intention to User If |
|---|---|---|
| Intention 1 | Refinance first mortgage | Current balance on primary |
| | | mortgage > $0 |
| Intention 2 | Refinance second | Current balance on second |
| | mortgage | mortgage > $0 and/or maximum |
| | | line of credit available > 0 |
| Intention 3 | When refinancing current | Current balance on primary |
| | mortgage(s), take | mortgage > $0 and/or current |
| | additional cash out | balance on second mortgage > $0 |
| | | and/or maximum line of |
| | | credit available > 0 |
| Intention 4 | Establish a home equity | Always display as an option |
| | loan or line of credit. | |

Once the appropriate intentions are determined, they are displayed to the user. The user can select any combination of the intentions displayed he/she they wishes to pursue. The intentions selected by the user will then determine the intention scenario. The intention scenario will then be associated with the available refinance strategies to recommend to the user based on the tables below.

| | Intentions Scenarios | | | | | | | |
|---|---|---|---|---|---|---|---|---|
| Intentions | 1 | 2 | 3 | 4 | 5 | 6 | 7 | 8 |
| 1 - Refinance first mortgage | X | | | X | X | X | | X |
| | (no current | | | | | | | (current |
| | 2^{nd} mtg.) | | | | | | | 2nd mtg.) |
| 2 - Refinance second mortgage | | X | | X | | X | X | |
| 3 & 4 - When refinancing current | | | X | | X | X | X | |
| mortgage(s), take additional cash | | | | | | | | |
| out and/or establish a home equity | | | | | | | | |
| loan or line of credit. | | | | | | | | |

| | Strategies Recommended Based | | | |
|---|---|---|---|---|
| | on Intentions Scenario & Availability | | | |
| | Strategy | | | |
| Scenarios | One | Strategy Two | Strategy Three | Strategy Four |
| 1 | Yes | | Yes | |
| 2 | | | | Yes |
| 3 | | | Yes | Yes |
| 4 | Yes | | Yes | |
| 5 | | Yes | Yes | |
| 6 | | Yes | Yes | |
| 7 | | | | Yes |
| 8 | Yes | | | |

Strategy One—First mortgage rate & term refinance (with Mortgage 100 only if needed based on LTV).

Strategy Two—First mortgage standard cash out refinance and cash out refinance with Mortgage 100.

Strategy Three—Flexible First.

Strategy Four—Second mortgage: home equity loan or line of credit.

Strategy One Product Recommendation Logic: Strategy One will be offered to the user either with a traditional down payment or with Mortgage 100, depending on the loan to value. With either option for Strategy One, the Advisor will follow the same product recommendation process.

If the user selects Strategy One to do a rate and s term refinance on his/her current mortgage (with or without Mortgage 100), the advisor collects information to determine what is the best product to use with this strategy. The user is asked to select his/her primary goal of refinancing. The options available to the user are:

Goal 1. Minimizing the monthly payment to permit investment of extra cash, even if it means not reducing the loan balance as quickly.

Goal 2. Reducing the term of the mortgage, while making the same payment as on the current mortgage(s).

Goal 3. Increasing the monthly payment so that the mortgage is paid off in a specific number of years. If this option is selected, the user must indicate the number of years.

Based on the goal selected, information will be gathered about the user's current mortgage(s):

Goal 1 requires the following information:
Monthly principal and interest payment for each mortgage;
If the current mortgage(s) is/are adjustable, the user's estimated average monthly payment over the remaining term of the mortgage(s).

Goal 2 requires the following information:
Monthly principal and interest payment for each mortgage;
Remaining term of the first mortgage.

Goal 3 does not require collection of additional information.

Once information is gathered from the user about his/her current mortgage(s), the advisor will collect the information necessary to score the available products for recommendation purposes.

Strategy Two Product Recommendation Logic: Strategy Two will be offered to the user either with a traditional down payment or with Mortgage 100, depending on the loan to value. With either option for Strategy Two, the advisor will follow the same product recommendation process.

If the user selects Strategy Two to take additional cash out of his/her property by refinancing the first mortgage (with or without Mortgage 100), the advisor provides the user with the maximum available equity that the user would have available after paying off the first mortgage. The user can then either accept the maximum amount of available equity or indicate an amount less then the maximum that he/she would like to access.

The advisor then collects information to determine what is the best product to use with this strategy. The user is asked to select a baseline product for comparison purposes from the current available products. The user is also asked to indicate his/her primary goal when refinancing. The options are:

Goal 1. Minimizing the monthly payment to permit investment of extra cash, even if it means not reducing the loan balance as quickly.

Goal 2. Minimizing the monthly payment for purposes other than investment of extra cash, even if it means not reducing the loan balance as quickly.

Goal 3. Reducing the loan balance, even if this means paying a higher monthly payment

By selecting Strategy Two, the user has indicated that he/she wants to not only refinance his/her current mortgage, but also access additional equity that is available. As a result, no information will be gathered about the user's current mortgage(s), other than the balances that have already been gathered during the product availability questions. The advisor will next collect information necessary to score the available products for recommendation purposes.

Strategy Three Product Recommendation Logic: If the user selects Strategy Three to refinance his/her first mortgage, and simultaneously to establish an equity line of credit, the advisor provides the user with the maximum available equity available after pay-off of the first mortgage. The user can then determine if he/she would like to is have this additional equity made available as cash at closing or as a line of credit for future needs.

Once the user has indicated an amount of cash the he/she would like to have available at closing, the user is presented with a recommended first mortgage amount (equal to the current first mortgage balance plus the cash the user would like at closing) and an equity line amount. Certain amounts are suggested and the user can override the recommended amounts within the following guidelines:
The total of the new first mortgage and equity line amounts cannot exceed the maximum combined loan amount for the user's situation;
The first mortgage amount must be more than the state minimum, but cannot exceed the state maximum;
The amount of the equity line of credit must be more than the state minimum or Flexible First minimum (whichever is greater), but cannot exceed the maximum combined loan amount minus the minimum first mortgage amount for the user's state.
   The advisor then collects information to determine what is the best first mortgage product to use with the home equity line of credit for this strategy. The user is asked to indicate his/her primary goal when refinancing. The options to the user are:

Goal 1. Minimizing the monthly payment so as to permit investment of extra cash, even if it means not reducing the loan balance as quickly.

Goal 2. Minimizing the monthly payment for purposes other than investment of extra cash, even if it means not reducing the loan balance as quickly.

Goal 3. Reducing the loan balance, even if this means paying a higher monthly payment.

Once information is gathered from the user about his/her current mortgage(s), the advisor will collect the information necessary to score the available first mortgage products for recommendation purposes.

Strategy Four Product Recommendation Logic: If the user selects Strategy Four to establishing a home equity loan is or line of credit, he/she is presented with two options:

Option 1: Adjustable-rate home equity line of credit;

Option 2: Fixed-rate home equity loan.

The user is provided with the maximum available equity that can be accessed with each option, as well as the features and benefits of each option. The user is asked to select the option that he/she prefers and to indicate the line-of-credit amount or loan amount that he/she is interested in establishing, with the following guidelines:

The total of the current first mortgage and the new equity line or equity loan amounts cannot exceed the maximum combined loan amount for the user's situation.

The amount of the equity line of credit or equity loan selected must be more than the state minimum, but cannot exceed the maximum combined loan amount minus the minimum first mortgage amount for the user's state.

Once the user has selected the option, he/she is presented with the available products that support the selected option. Since this strategy does not use the product scoring selection process, for each available product, a brief summary for the home equity line of credit products is provided to assist the client in selecting the product that would best meet his/her needs, as follows:

Option 1: Adjustable-rate home equity line of credit:
Equity Access 10 year interest-only home equity line of credit;
Equity Access Prime 10 year interest-only home equity line of credit;

Option 2: Fixed-rate home equity loan:
7 year fixed-rate home equity loan;
10 year fixed-rate home equity loan;
15 year fixed-rate home equity loan;
30 year fixed-rate home equity loan.

Refinance Advisor—Product Scoring: Once the user has selected refinance Strategy One, Two or Three, the advisor asks a series of questions to use in scoring the available first mortgage products that can be used with the selected strategy. The following information is gathered from the user:

1. How long the user plans to own the property—holding period;

2. Income trend:
Stay the same;
Increase;
Decrease;

3. Monthly income variance:
More than 25%;
Less than 25%;

4. Preference on payment fluctuations:
No fluctuation;
Minimal fluctuation;
Frequent fluctuations;

5. Interest rate forecast:
Stay the same;
Increase gradually (¼% per year);
Increase moderately (½% per year);
Decrease gradually (¼% per year);
Decrease moderately (½% per year);
Increase then decrease gradually (¼% per year);
Increase then decrease moderately (½% per year);
Decrease then increase gradually (¼% per year);
Decrease then increase moderately (½% per year);

6. Comparison product selected from all available products—collected for strategies 2 & 3 only;

7. Home refinancing goal:
Low monthly payment for investing the difference—option for all strategies;
Low monthly payment, without investing difference—option for all strategies;
Loan balance reduction—option for strategies 2 and 3 only;
Reducing mortgage term, while making the same payment as on current mortgage(s)—option for strategy 1 only;
Monthly payment Increase to pay off mortgage in a specific number of years—option for strategy 1 only.

Based on the holding period for the property, each available first mortgage product is classified into one of the following categories:
30 year fixed;
15 year fixed;
Fixed amortizing;
Fixed interest only;
Fixed to adjustable amortizing;
Fixed to adjustable interest only;
6 month adjustable;
1 month adjustable.
   (Thus, for example, if the client has a 7 year holding period, the 7 and 10 year interest only product will be classified as fixed interest only and the 5 year interest only will be classified as fixed to adjustable interest only.)

Once all the available products are classified, each product is scored based on its classification and the information the user provided for his/her income trend, income variance, and comfort level with payment fluctuations. The following matrix summarizes how each product will score points based on the user's answers to the questions:

| | 30 | 15 | FA | FIO | FTAA | FTAIO | A6 | A1 |
|---|---|---|---|---|---|---|---|---|
| Income | | | | | | | | |
| Trend | | | | | | | | |
| Increase | 0 | 0.25 | 0.25 | 0.5 | 0 | 0.5 | 0.5 | 0.5 |
| Stay the | 0.75 | 0.75 | 0.75 | 0.75 | 0 | 0 | 0 | −0.5 |
| same | | | | | | | | |
| Decrease | 1.25 | −3 | 1 | 2 | −0.5 | −0.5 | −0.5 | −1 |
| Comfort | | | | | | | | |
| Level | | | | | | | | |
| Low | 1 | 1 | 1 | 1 | −0.5 | −0.5 | −3 | −3 |
| Moderate | 0 | 0 | 0 | 0 | 0 | 0 | 0 | −1 |
| High | 0 | 0 | 0 | 0 | 0.5 | 0.5 | 1 | 1 |
| Income | | | | | | | | |
| Variance | | | | | | | | |
| Yes | 1 | 0.5 | 1 | 1.25 | 0 | 0 | −0.25 | −0.5 |
| No | 0 | 0 | 0 | 0 | 0 | 0 | 0 | 0 |

| | |
|---|---|
| Key | |
| 30 | 30 year fixed |
| 15 | 15 year fixed |
| FA | Fixed Amortizing |
| FIO | Fixed Interest Only |
| FTAA | Fixed to Adjustable Amortizing |
| FTAIO | Fixed to Adjustable Interest Only |
| A6 | Adjustable 6 month |
| A1 | Adjustable 1 month |

If the product is classified as a 30-year fixed, 15-year fixed, fixed amortizing, or fixed interest only, the product will receive an additional 0.35 points.

Each product receives a score for income trend, income variance, comfort level with payment fluctuation, and if the product rate is fixed. These scores are added together to come up with 40% of the total product score.

Next, the Home Refinance Advisor performs calculations to come up with the remaining 60% of the total product score. The calculation performed is based on the home-refinance goal selected by the user. If the calculation involves calculating monthly payments for the product (for payment savings or average payments), the user's forecast of interest rates is used when determining adjustable payments in the payment schedule. The system also factors in any interest rate caps when making these payment adjustments based on the user's interest rate forecast.

The Home Refinancing goals and accompanying calculations are listed below:

| Home Refinancing | |
|---|---|
| Goal | Calculation Performed |
| Low monthly payment | Payment savings growth over the holding period |
| for investing | |
| the difference | |
| Low monthly | Lowest average payment over the holding period |
| payment, without | |
| investing difference | |
| Loan balance | Highest principal reduction per payment over the |
| reduction | holding period |
| Reducing mortgage | Reverse amortization with payment, rate and loan |
| term, while making | amount to determine term |
| the same payment as | |
| on current mortgage(s) | |
| Monthly payment | Amortization with term, rate and loan amount to |
| Increase to pay off | determine payment |
| mortgage in a specific | |
| number of years | |

The following explains how each of the calculations is performed:

Payment savings growth is calculated based on the difference in the payment for the product and the payment for the base (comparison) product selected by the user. The future value of each difference is calculated based on the holding period and the investment rate-of-return the user enters. The future value of each payment savings is summed to compute a total payment savings growth over the holding period.

Lowest average payment is calculated by adding each of the payments over the holding period and dividing it by the holding period (in years) times 12.

Highest principal reduction per payment is calculated by adding the principal paid for each payment over the holding period and dividing it by the holding period (in years) times 12.

Reducing mortgage term, while making the same payment as on current mortgage(s), is calculated by taking the client's current mortgage payment, new product's term, new product's rate, loan amount and calculating the term of the new product based on the current mortgage payment amount. Any products that do not reduce the term below the current term are not considered for recommendation. The product that produces the lowest term is scored the highest for the goal.

Monthly payment increase to pay off mortgage in a specific number of years is calculated by taking the term provided by the client, the new product's rate and loan amount to calculate an amortizing payment. The product with the lowest amortizing payment over the term provided by the client is scored the highest for the goal.

After all products have received a score based on the goal, a total score is calculated for each product by adding the total product score and the goal score together. These scores are then recalculated on a 100-point scale. The product with the highest total score is considered the “best” product. Each product's total score is then compared to the “best” product's total score and a % difference is calculated. This percentage difference is then subtracted from 100% to determine the score that is displayed to the user. For example, the “best” product will receive a score of 100% and a product that has a 20% difference from the “best” product will receive a score of 80%.

The advisor then recommends the two products with the highest scores, and the base product initially selected by the user. If the base product has one of the two highest scores, then the product with the third highest score is displayed as well. If no base product has been selected, then the three products with the highest scores are recommended.

Just as in the Purchase Advisor, from the refinance recommendation screen the user has the ability to access loan detail information for one of the recommended products, as well as a list of all available products for the user's specific scenario.

Refinance Advisor—Special Considerations:

1. A separate “Other Rate Options” screen is provided to accommodate the Fixed-Rate Home Equity Loans due to the fact that these products are offered with both a no-points option and a no closing costs option.

2. Special edits are used to accommodate Texas homestead properties. When the user indicates that he/she has a primary residence in Texas, the user is referred to a screen that has the user contact MLCC's Loan Consulting to discuss financing options.

3. Due to different LTVs for the Flexible First program when it is used with a conforming versus nonconforming product in a cashout refinance scenario, conforming products are excluded for use with the Flexible First cash-out option.

On-Line Application Submission Detail: The Apply section of the web site presents the user with the different methods available to the user in applying for a mortgage with MLCC. Based on the type of user accessing the Apply section, as well as the property state location and FC location, the following methods to apply may be displayed:

Applying over the phone with a Loan Consultant;

Applying through the mail by calling MLCC and requesting an application;

Applying online via the Mortgage and Credit Solutions web site.

Availability of OnLine Application Functionality: Due to state licensing issues, an FC or CA will only be given access to the Online Application functionality when both the consultant's office and the subject property are located in approved states. If either of these conditions are not met, the user will not see the Apply Online option on the Apply Landing page.

If the user is an MLCC partner or an MCS, he/she will have access to the Apply Online option regardless of his/her physical location and the subject property location.

OnLine Application Process for FCs: For compliance reasons, FCs must provide clients with the necessary state and federal disclosures during the online application process with the client. As a result, once the FC has collected the online application information from the client, he/she will be provided with a screen from which he/she will print the following items:
Federal disclosure documents based on the product selected;
State disclosure documents based on the property state and product selected;
A data sheet containing the application information that can be signed by the client and returned to MLCC.

On-Line Application Statuses: A Credit Advisor session and online application goes through the following statuses as it is prepared, submitted and received by MLCC:
Credit Advisor Session—this status applies to all records that have not begun the online application process;
Application Incomplete—this status applies to any partially complete online application;
Submitted Application—this status indicates that the user has completed the online application and submitted it to MLCC for processing. This is the status that will cause the application to appear in the Application Submitted Queue and render the record read-only if the user accesses it again. The loan will stay in this status until it is printed from the queue.
Printed Application—once an online application has been printed from the Application Submitted Queue, it will remain in this status until purged from the Credit Advisor database.

Application Submitted Queue: Once the user has submitted an online application to MLCC, the status becomes Submitted Application. This status causes the record to appear in the Application Submitted Queue and also triggers an email message to the appropriate Lending Services partners to let them know a new application is ready for processing. Records remain in the Application Submitted Queue as long as their status is Submitted Application. For each record in the queue, the following information is displayed:
Time the application has been in the queue;
Application status;
Status time;
Applicant name;
Application number;
Property state;
District;
Who the application is assigned to (e.g., Loan Consulting or Cendant);
Conforming loan indicator (when a conforming product is used with Mortgage 100 or Parent Power, the loan is considered non-conforming and is not forwarded to Cendant for processing).

The records in the queue can be sorted by any of the column headers identified above. When a Lending Services user is ready to print an application from the queue, he/she will select the application from the queue list, assign it to Loan Consulting or Cendant from a drop down list at the bottom of the screen, and select the Print/E-mail button. This will open the application in the report viewer. Within the viewer, he/she can print the application, or save it and e-mail it to Cendant. Once an application is printed or e-mailed, it will remain in the queue for 72 hours. If the user needs to reprint an application that is no longer in the queue, there is a search link provided on the page.

Retrieving and Validating Partial Application Sessions: When a partially completed application session is retrieved by a user, product availability is automatically rerun to verify the original selected product is still available based on the user's situation. If the originally selected product is not available, the user is directed to product availability in order to select a new product. If the is original product is still available, the user is taken to the online application pages.

Review Product Selection Page: Before the user can complete the online application, he/she must go through product availability to select an available product. Once the user has selected an available product and entered the online application, is presented with a summary of the product availability information. If they wishes to change any of this information, he/she must go back through product availability to ensure the selected product is still acceptable based on any information they change.

About the Property Page: The following information is gathered on this screen:
Property address;
Estimated closing date for this mortgage;
Name in which the title will be held;
How will the title be held:
   Solely;
   Jointly with spouse;
   Jointly with another person;
   Revocable trust;
The Property is currently:
   Listed for sale;
   Under construction;
   Under renovation;
   Subject to a contract of sale;
   Being used commercially;
   Held in a revocable trust;
Is this purchase a result of a company relocation.

New York Co-op Information Page: The following information is gathered on this screen:
Cooperative corporation (Co-op) name;
Managing agent's name;
Managing agent's mailing address;
Managing agent's telephone number;
Number of shares owned (for the co-op unit);
Maximum loan-to-value (LTV) permitted by cooperative corporation.

Information about your Current Mortgage Page: The following information is gathered about the applicant's current property/mortgage on this screen:
Original purchase price of the property;
Purchase date of the property;
Mortgage balance (if applicable) for the property;
Mortgage payment(s), including both principal and interest (if applicable);
Monthly property tax payment;
Monthly homeowner's insurance premium;
Monthly association/co-op dues (if applicable);
Monthly mortgage/flood insurance premium (if applicable).

Information About the Property's Insurance, Property Tax, and Fees Page: The following information is gathered on this screen about the applicant's proposed property/mortgage:
Monthly property tax payment;
Monthly homeowner's insurance premium;
Monthly association/co-op dues (if applicable);
Monthly flood insurance premium (if applicable).

Persons to Contact Page: The following contact information is gathered on this screen:
Appraisal contact name;
Appraisal contact phone number;
Parent Power sponsor's name;
Parent Power sponsor's mailing address;
Merrill Lynch financial consultant name;
Financial consultant phone number;
Financial consultant office number;
Financial consultant producer number.

List Applicant(s) Names Page: The following applicant information is gathered on this screen:
Applicant 1 name;.
Applicant 2 name;
Applicant 3 name;
Applicant 4 name.

Personal Information Page: The following information is gathered on this screen:
First name;
Middle initial;
Last name;
Home phone number;
Date of birth;
Social security number;
Current marital status:
   Unmarried (single, widowed, divorced);
   Married;
   Separated;
Citizenship:
   US citizen;
   Resident alien (green card holder);
   Non-resident alien;
Only asked to co-applicant—Do you share your current residence with the “Primary Applicant”?
Do you own or rent your current residence?
Do you own any properties other than your current primary residence?

Current Residence Information Page: The following information is gathered on this screen: (This screen is not presented to co-applicants if they have indicated above that they share their current residence with the primary applicant.)
Current residence address;
Years at present address;
Property manager's name;
Property manager's mailing address;
Property manager's phone number.

Information About Your Previous Residence Page: If the applicant has been in his/her current residence less than two years, the following information is gathered on this screen:
Rent or own previous residence;
Previous residence address;
Years at this address;
Property management or lender's name;
Property management or lender's address;
Property management or lender's phone number;
Mortgage account number (if applicable).

Current Owned Real Estate Page: The following information is gathered on this screen:
Property address;
Property type:
   single family;
   Multi-family;
   Commercial;
   Land only;
   Condo;
   Co-op;
Percent Owned by all applicants (if more than one owner);
Years at present address;
Estimated present market value;
Current mortgage balance (if applicable);
Monthly rental income (if applicable);
Current mortgage payment, include principal and interest (if applicable);
Current interest rate type:
   Fixed;
   Adjustable;
Monthly tax, insurance and dues (if applicable);
Current lender's name (if applicable);
Lender's address;
Is this property listed for sale?
   If yes, is there a signed contract of sale on the property?

Schedule of Real Estate You Own Page: The following information is gathered on this screen for each additional property:
Property address;
Property type;
% Owned;
Present value;
Amount of mortgage;
Mortgage payment;
Fixed or adjustable rate;
Current residence—yes or no;
Monthly rental income;
Monthly taxes, insurance and dues;
Lender name;
Account number;
Lender address.

Your Employment Information Page 1: The following information is gathered on this screen:
Employment status:
   Employed/salaried;
   Self-employed;
   Part time;
   Retired;
   Homemaker;
   Other;
If Self-employed, what percentage of the business do you own?

Your Employment Information Page 2: If the user indicated an employment status other than retired, the following information is gathered on this screen:
Current employer or business name;
Current employer or business address;
Work phone number;
Line of work;
Position or title held;
Employed from;
Years in line of work/profession;
Monthly salary;
Monthly commission income (if applicable);
Monthly bonus income (if applicable).

Information About Your Previous Employer Page: If the user has indicated that his/her current employment has been for less than 5 years, the following information is gathered on this screen:
Employer or business name or was not previously employed;
Employer or business address;
Employer or business phone number;
Line of work;
Position or title held;
Employed from/to;
Years in line of work/profession;
Monthly income.

Income Information Page: The following information is gathered on this screen:
Monthly salary;
Commission;
Bonus;
Dividend income;
Interest from accounts;
Net rental income;
Social security;
Other income, such as trust fund, pension, alimony/child support.

About Your Business Interests Page: The following information is gathered on this screen:
Name of business;
Percentage of business owned;
Type of business:
   Corporation;
   Subchapter S corporation;
   Limited partnership;
   General partnership;
Amount of future capital contributions.

Your Accounts and Assets held Outside of Merrill Lynch Page: The following information is gathered on this screen for each account:
Account holder:
   Applicant;
   Co-applicant 1;
   Co-applicant 2;
   Co-applicant 3;
Manner Held:
   Solely;
   Jointly w/co-applicant;
   Jointly with a 3rd party;
Account Type:
   Checking & savings;
   IRA;
   Cash/money market;
   Marketable securities;
   Securities held privately;
   401K;
   Notes receivable;
Institution name;
Institution address;
Account number;
Balance.

Asset Eligibility Questions Page: The following information is gathered on this screen:
Do any of your accounts contain stock in a company for which you or the co-applicant (if applicable) serve as a member of the Board of Directors or Executive Management?
Have you included any unexercised stock options in the asset total you stated?
Are any of these assets held by a business in which you are not a 100% owner?
Are any of the assets held by a depositor, other than Merrill Lynch, margined, or being held as collateral?

Obligations Not Reflected On Your Credit Report Page: The following information is gathered on this screen:
Monthly alimony;
Monthly child support;
Job-related expenses (childcare, union dues, etc.);
Other.

Credit Related Questions Page: The following information is gathered on this screen:
May your credit reference/history be verified under any other name? If so, what name?
Are there any outstanding judgments against you?
Have you declared bankruptcy within the past 7 years? If yes, when? Was the bankruptcy dismissed?
Have you had a property foreclosed upon, or given title or deed in lieu thereof in the last 7 years? If yes, when?
Are you a party to a lawsuit?
Have you directly or indirectly been obligated on any mortgage, which resulted in foreclosure, transfer or title in lieu of foreclosure or judgement?
Are you presently delinquent or in default on any federal debt or any other loan, mortgage, financial obligation bond or loan guarantee?
Are you obligated to pay alimony, child support or separate maintenance?
Are you a co-maker or endorser on a note?
If this is a purchase money mortgage, will any of the funds you intend to use for the down payment be borrowed?
Have you had an ownership interest in any other property in the last 3 years?
If yes, what type?
   Principal Residence;
   Second Home;
Investment Property;
How was title held?
   Solely;
   Jointly with Spouse;
   Jointly with another Person;
   Revocable Trust;
Do you intend for the property to be your primary residence?
Will any portion of the loan proceeds be used for commercial or business purposes (e.g., for the purposes of providing funds for your business or to acquire investment property)?
Are you or any member of your immediate family, or any associate or related organization,
   An executive officer, member of the board of directors, or holder or beneficial owner of ten percent (10%) or more of any class of voting stock or Merrill Lynch & Co., Inc. or any of its subsidiaries? If yes, provide name and position of individual(s);
   Related to, or an associate of, a member of the board of directors, or holder or beneficial owner of ten percent (10%) or more of any class of voting stock of Merrill Lynch & Co., Inc. or any of its subsidiaries? If yes, provide name and position of individual(s)

Government Information Page: The following information is gathered on this screen:
I do not wish to furnish this information;
What is your sex?
Race/national origin:
American indian, Alaskan native;
Asian, Pacific islander;
Black;
Hispanic;
White;
Other, please specify.

Acknowledgments and Agreements Page (Client Only): On this screen the user will review the Acknowledgments and Agreements from the loan application and indicate that he/she accepts these terms before continuing to the final screens of the online application.

Summary of Mortgage Application Page: On this screen the user will review the information that has been entered on the previous screens. The information on this page is separated into the categories listed below. For each category a ✓ symbol (section complete) or X symbol (incomplete section) is displayed that will tell the user if there are required fields in this section that still need to be completed before the application can be submitted.

If the user needs to make any changes, he/she is instructed to click on the symbol located beneath the appropriate section to modify the information. If there are no changes to be made, the user is instructed to print the summary page for his/her records.

Next Steps Page (FCs & CAs only): If the user is an FC or CA, he/she is presented with a static screen that contains information outlining what documents the client must sign and how to obtain the mortgage folder that must be provided to the client.

You're Finished Page: Once the user has selected the Submit button, the application data is saved to the Credit Advisor Database and a Credit Advisor application number is assigned to the record. The user is presented with the application number on this page for future reference.

My Account and Search & Retrieve Functionality: The My Account section of the site provides the user with access to current MLCC account information, as well as previously saved Credit Advisor and Online Application sessions. Through the Mortgage and Credit Account information link, the user is taken to the current MLCC InSite web site, where he/she can access information on MLCC loans in process and servicing. Through the Credit Advisor and Application Session link, the user can access and continue existing Credit Advisor and Loan Application sessions already in progress.

MLCC partners are also given expanded search capabilities from the Lending Services landing page using the Search Sessions link.

Mortgage and Credit Account information: When the user selects the Mortgage and Credit Account information link, he/she is taken to the current MLCC InSite web site. If the user is an FC or CA, he/she will have access to any loans in process or servicing that are associated with his/her producer number. For loans in processing, the FC or CA will have the ability to access the most current status and loan information, as well as be given the name of the appropriate MLCC partner who is currently processing the loan. For loans in servicing, the FC will have access to information about payments received, balances, interest rates, and taxes for is current MLCC mortgages and credit lines.

If the user is not an FC, he/she will only have access to any loans he/she personally has in servicing at MLCC, based on the loan number and the last four digits of the user's social security number. For these loans, the user will also have access to information about payments received, balances, interest rates, and taxes.

FC Retrieval of CreditAdvisor and Application Sessions: If the user is an FC or CA, when he/she accesses the Credit Advisor and Application Session link, he/she is provided with a listing of any Credit Advisor and Loan Application sessions already in progress under his/her producer number. For each session, he/she will be provided the following information:
Type of session—CreditAdvisor or Application;
Client/applicant name;
Property address;
Merrill Lynch account number;
Last modified date;
Session status.

The list of sessions can be sorted by any of the column headings identified above.

To continue with any of these sessions, the user selects the session from the list and the session will be retrieved. The user also has the ability to start a new session from this page.

Lending Services Retrieval of Credit Advisor and Application Sessions: From the Lending Services Landing page, the user can access the Search Sessions link and is taken to the session search page. On this page, a session can be searched using any combination of the following criteria:
Client/applicant first name;
Client/applicant last Name;
Client/applicant social security number;
Session type—Credit Advisor or Application;
Application status;
Status dates;
Reference number (also referred to as Application Number);
Property address;
FC office/producer number;
District.

When the user makes a search request, he/she will be provided with a list of saved records that match the criteria provided. For each record returned, the following information is displayed:
Client/applicant name;
Session type;
Session status;
Status date;
Property address;
FC office/producer number;
Reference number;
Loan product.

The list of sessions can be sorted by any of the column headings identified above. To continue with any of these sessions, the user will select the session from the list and the session will be retrieved. The user also has the ability to start a new session from this page.

If any of the records returned are applications, the user is also provided with the ability to print the application datasheet for the selected record.

Saving Sessions: A Save button is located on the bottom of most pages within the advisor tools and the online application. At any time during these sessions, the user can is select this button to save the information he/she has provided up to this point in the Credit Advisor database. When the user selects the Save button, he/she prompted for the following information:
Client first name;
Client last name;
Property address;
Merrill Lynch account number (optional);
FC office/producer # (only displayed if the user is an FC or CA).

The user is notified that his/her information has been saved and will be available for 30 days, and that to access the information upon return to the site, he/she should go to the “My Account” section. After receiving this confirmation, the user can select from one of the following options:
Continue the session with the information just saved;
Start a new session with new information;
Clear out the old session and leave the site.

Starting New Sessions: A New Session button is located in the navigation bar at the top of each page within the site. If the user wishes to start a new session, he/she selects this button. The user will then be asked if he/she wishes to save the current session information prior to starting the new session. If the user selects no, the session data will be erased and the user will be taken to the home page. If the user selects yes, he/she will be taken to the session save screen.

While the foregoing has described and exemplified aspects of a presently-preferred embodiment of the instant invention, those skilled in the art will recognize that alternative elements and techniques, and/or combinations and sub-combinations of the described elements and techniques, can be substituted for, or added to, the embodiment described herein. The present invention, therefore, should not be limited to, or defined by, the specific apparatus, methods, and articles-of-manufacture described herein, but rather by the appended claims, which are intended to be construed in accordance with well-settled principles of claim construction, including, but not limited to, the following:

Limitations should not be read from the specification or drawings into the claims (e.g., if the claim calls for a “chair,” and the specification and drawings show a rocking chair, the claim term “chair” should not be limited to a rocking chair, but rather should be construed to cover any type of “chair”).

The words “comprising,” “including,” and “having” are always open-ended, irrespective of whether they appear as the primary transitional phrase of a claim, or as a transitional phrase within an element or sub-element of the claim (e.g., the claim “a widget comprising: A; B; and C” would be infringed by a device containing 2A's, B, and 3C's; also, the claim “a gizmo comprising: A; B, including X, Y, and Z; and C, having P and Q” would be infringed by a device containing 3A's, 2X's, 3Y's, Z, 6P's, and Q).

The indefinite articles “a” or “an” mean “one or more”; where, instead, a purely singular meaning is intended, a phrase such as “one,” “only one,” or “a single,” will appear.

Where the phrase “means for” precedes a data processing or manipulation “function,” it is intended that the resulting means-plus-function element be construed to cover any, and all, computer implementation(s) of the recited “function” using any standard programming techniques known by, or available to, persons skilled in the computer programming arts.

A claim that contains more than one computer-implemented means-plus-function element should not be construed to require that each means-plus-function element must be a structurally distinct entity (such as a particular piece of hardware or block of code); rather, such claim should be construed merely to require that the overall combination of hardware/software which implements the invention must, as a whole, implement at least the function(s) called for by the claims.

1-41. (canceled)

42. A method for providing mortgage and/or credit services over the Internet, comprising:
selectively providing information concerning a plurality of mortgage and/or credit programs to an Internet-connected user;
receiving, from said Internet-connected user, an indication of whether said user wishes to explore home financing options or home equity loan options;
receiving, from said Internet-connected user, an indication of whether or not said user maintains an asset and/or brokerage account with a sponsor of said mortgage and/or credit services;
receiving, from said Internet-connected user, an indication of said user's residence;
receiving, from said Internet-connected user, information concerning a property to be financed, said information including at least location, expected holding period, and use of said property;
receiving, from said Internet-connected user, information concerning said user's investments;
processing said received indications and information to determine mortgage and/or credit option(s) that correspond to said user's needs; and
presenting said mortgage and/or credit option(s) to said user via the Internet.

43. A method as in claim 42, wherein selectively providing information concerning a plurality of mortgage and/or credit programs includes selectively providing information concerning zero-down payment and conventional mortgage programs.

44. A method as in claim 42, wherein selectively providing information concerning a plurality of mortgage and/or credit programs includes selectively providing information concerning fixed-rate and adjustable-rate options.

45. A method as in claim 42, wherein selectively providing information concerning a plurality of mortgage and/or credit programs includes selectively generating pdf-format print files concerning selected mortgage and/or credit programs.

46. A method as in claim 42, wherein receiving, from said Internet-connected user, information concerning a property to be financed includes receiving an indication of whether said property is a single family home, condominium, multi-family residence, or commercial property.

47. A method as in claim 42, wherein receiving, from said Internet-connected user, information concerning said user's investments includes receiving information concerning the aggressiveness of said investments.

48. A method as in claim 42, wherein receiving, from said Internet-connected user, information concerning said user's investments includes receiving information concerning the expected rate-of-return on said investments.

49. A method as in claim 42, wherein receiving, from said Internet-connected user, information concerning said user's investments includes receiving information concerning the value of non-retirement securities held by said user.

50. A method as in claim 49, wherein receiving, from said Internet-connected user, information concerning said user's investments further includes receiving information concerning the portion of said non-retirement securities already pledged as collateral by said user.

51. A method as in claim 42, wherein presenting said mortgage and/or credit option(s) to said user via the Internet includes providing a tabular comparison of at least three different down payment options.

52. A method as in claim 51, wherein providing a tabular comparison of down payment options includes providing a information concerning the costs/benefits of investing potential down payment funds.

53. A method as in claim 42, wherein presenting said mortgage and/or credit option(s) to said user via the Internet includes providing at least three options, each scored according to how well it meets the user's needs.

54. A method as in claim 53, wherein s presenting said mortgage and/or credit option(s) to said user via the Internet further includes selectively providing explanatory information concerning why the first option is the best option for the user's needs.

55. A method as in claim 42, wherein presenting said mortgage and/or credit option(s) to said user via the Internet includes selectively providing a comparison of one or more system-recommended option(s) with one or more user-selected option(s).

56. A computer-based system for providing mortgage and/or credit services over the Internet, comprising:
http-responsive means for selectively providing information concerning a plurality of mortgage and/or credit programs to an Internet-connected user;
http-responsive means for receiving, from said Internet-connected user, an indication of whether said user wishes to explore home financing options or home equity loan options;
http-responsive means for receiving, from said Internet-connected user, an indication of whether or not said user is an employee of the sponsor of said mortgage and/or credit services;
http-responsive means for receiving, from said Internet-connected user, an indication of said user's residence;
http-responsive means for receiving, from said Internet-connected user, information concerning a property to be financed;
http-responsive means for receiving, from said Internet-connected user, information concerning said user's investments;
means for processing said received indications and information to determine at least three mortgage and/or credit options that best match said user's needs; and,
http-responsive means for presenting said mortgage and/or credit options to said. user via the Internet.

57. A computer-based system as in claim 56, wherein said means for selectively providing information concerning a plurality of mortgage and/or credit programs includes means for selectively providing information concerning zero-down payment and conventional mortgage programs.

58. A computer-based system as in claim 56, wherein said means for selectively providing information concerning a plurality of mortgage and/or credit programs includes means for selectively providing information concerning fixed-rate and adjustable-rate options.

59. A computer-based system as in claim 56, wherein said means for selectively providing information concerning a plurality of mortgage and/or credit programs includes means for selectively generating pdf-format print files concerning selected mortgage and/or credit programs.

60. A computer-based system as in claim 56, wherein said means for receiving, from said Internet-connected user, information concerning a property to be financed includes means for receiving an indication of whether said property is a single family home, condominium, multi-family residence, or commercial property.

61. A computer-based system as in claim 56, wherein said means for receiving, from said Internet-connected user, information concerning said user's investments includes means for receiving information concerning the expected rate-of-return on said investments over the expected holding period.

62. A computer-based system as in claim 56, wherein said mean for receiving, from said Internet-connected user, information concerning said user's investments includes means for receiving information concerning the value of non-retirement securities held by said user.

63. A computer-based system as in claim 62, wherein said means for receiving, from said Internet-connected user, information concerning said user's investments further includes means for receiving information indicative of the portion of said non-retirement securities already pledged as collateral by said user.

64. A computer-based system as in claim 56, wherein said means for presenting said mortgage and/or credit options to said user via the Internet includes means for providing a tabular comparison of at least three different down payment options.

65. A computer-based system as in claim 64, wherein the means for providing a tabular comparison of down payment options also provides information concerning the costs/benefits of investing potential down payment funds.

66. A computer-based system as in claim 56, wherein said means for presenting said mortgage and/or credit options to said user via the Internet includes means for presenting at least three options, each scored according to how well it meets the user's needs.

67. A computer-based system as in claim 66, wherein said means for presenting said mortgage and/or credit options to said user via the Internet further includes selectively providing explanatory information concerning why the first option is the best option for the user's needs.

68. A computer-based system as in claim 56, wherein the means for presenting said mortgage and/or credit options to said user via the Internet includes means for is selectively providing a comparison of one or more system-recommended option(s) with one or more user-selected option(s).

69. A method for providing mortgage and/or credit services via a computer network, comprising:
selectively providing information concerning a plurality of mortgage and/or credit programs via the network to a network-connected user;
receiving, via the network from said network-connected user, an indication of whether said user wishes to explore home financing options or home equity loan options;
receiving, via the network from said network-connected user, an indication of whether or not said user maintains an asset and/or brokerage account with a sponsor of said mortgage and/or credit services;
receiving, via the network from said network-connected user, an indication of said user's residence;
receiving, via the network from said network-connected user, information concerning a property to be financed, said information including at least location, expected holding period, and use of said property;
receiving, via the network from said network-connected user, information concerning said user's investments;
processing on a computer said received indications and information to determine mortgage and/or credit option(s) that correspond to said user's needs; and
presenting said mortgage and/or credit option(s) to said user via the network.
